(19) United States
(12) Patent Application Publication
(10) Pub. No.: US 2016/0110268 A1
(43) Pub. Date: Apr. 21, 2016

(54) APPARATUS AND SUPPORT METHOD FOR STATE RESTORATION

(71) Applicant: FUJITSU LIMITED, Kawasaki-shi (JP)

(72) Inventors: Atsuji SEKIGUCHI, Kawasaki (JP); Toshihiro KODAKA, Yokohama (JP); Toshihiro SHIMIZU, Sagamihara (JP); Yukihiro WATANABE, Kawasaki (JP)

(73) Assignee: FUJITSU LIMITED, Kawasaki-shi (JP)

(21) Appl. No.: 14/977,149

(22) Filed: Dec. 21, 2015

Related U.S. Application Data
(63) Continuation of application No. PCT/JP2013/069622, filed on Jul. 19, 2013.

(51) Int. Cl. G06F 11/14

(52) U.S. Cl. CPC G06F 11/1469; G06F 11/1456; G06F 2201/84

(57) ABSTRACT

A storing unit stores therein information indicating a chronological order of a plurality of states of an apparatus; information indicating an amount of time needed to execute each of a plurality of commands, causing a forward or backward transition between two of the states; and information indicating an amount of time needed for restoration to, among the states, each state for which a snapshot has been taken, using the snapshot. Based on the information stored in the storing unit, a calculating unit calculates shortest operation paths, each for restoring the apparatus from a restoration origin state to one of the remaining states, and determines one or more snapshots not used in any of the shortest operation paths as deletion targets.

### CROSS-REFERENCE TO RELATED APPLICATION

This application is a continuation application of International Application PCT/JP2013/069622 filed on Jul. 19, 2013, which designated the U.S., the entire contents of which are incorporated herein by reference.

### FIELD

The embodiments discussed herein are related to a state restoration apparatus and a state restoration support method.

### BACKGROUND

Information processing systems including various types of apparatuses (such as computers, networking equipment, and storage devices) are in use today. Such an information processing system may back up data held by its apparatuses. Taking backups allow each of the apparatuses to be restored to its state at the time each backup was taken. Backups may be created, for example, periodically during the system being in operation or prior to each release work (such as a software update, a configuration parameter update, and an update of data being handled) for its system environment.

Various backup methods have been proposed. For example, data called a snapshot is periodically taken. A snapshot is an image of a predetermined area in a storage device, recorded at a particular point in time. For example, the contents of computers, virtual machines running on the computers, and databases may be recorded by snapshots. For example, a proposed backup method is concerned with making a backup by switching between taking a snapshot and taking a journal which is a record of a write to a logical volume. According to another proposed backup method, the oldest snapshot is deleted each time a new snapshot is created after the number of snapshots has reached the maximum.

See, for example, Japanese Laid-open Patent Publication Nos. 2007-80131 and 2007-280323.

Settings of an apparatus may be changed by sequentially giving a plurality of commands for setting changes (for example, changes of communication parameters) to the apparatus. To undo the changes, commands each for a setting change opposite to its corresponding command are sequentially given to the apparatus, which is then restored to the original settings. This restoration method may be used in combination with a restoration method using a snapshot. For example, a state at a particular point in time is restored using a snapshot, and commands for setting changes are applied to the state at the particular point so as to restore a desired state.

Note that snapshots are comparatively large in data size. Therefore, increased numbers of snapshots put pressure on the space of the storage device. The storage space could be saved by deleting snapshots, which, however, makes the deleted snapshots unavailable for restoration. This may result in an increased amount of time needed for restoration to a particular state. The reason of this is as follows.

Restoration using a snapshot often finishes within a predetermined time frame. On the other hand, the amount of time needed for its execution varies among commands for changing settings on an apparatus and also for undoing the changes. Some need less time while others take more time (for example, commands involving a restart of the apparatus). If, to restore the apparatus to a particular state, a command (or a series of commands) taking more time is executed in place of a deleted snapshot, the restoration is likely to take a longer time than before the snapshot being deleted. Therefore, what remains an issue is how to determine snapshots for deletion in consideration of the amount of time needed for restoration.

### SUMMARY

According to an aspect, there is provided a non-transitory computer-readable storage medium storing a state restoration program that causes a computer to perform a procedure including calculating, based on information indicating a chronological order of a plurality of states of an apparatus, information indicating an amount of time needed to execute each of a plurality of commands, causing a forward or backward transition between two of the states, and information indicating an amount of time needed for restoration to, among the states, each state for which a snapshot has been taken, using the snapshot, shortest operation paths, each for restoring the apparatus from a restoration origin state to one of the remaining states; and determining one or more snapshots not used in any of the shortest operation paths as deletion targets.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a state restoration apparatus according to a first embodiment;

FIG. 2 illustrates an information processing system according to a second embodiment;

FIG. 3 illustrates an example of hardware of a state restoration apparatus according to the second embodiment;

FIG. 4 illustrates an example of functions of the state restoration apparatus according to the second embodiment;

FIG. 5 illustrates an example of a state record table according to the second embodiment;

FIG. 6 illustrates an example of an operation execution record table according to the second embodiment;

FIG. 7 illustrates an example of a snapshot record table according to the second embodiment;

FIG. 8 illustrates an example of an operation information table according to the second embodiment;

FIG. 9 illustrates examples of operation data pieces according to the second embodiment;

FIG. 10 illustrates an example of a GUI according to the second embodiment;

FIG. 11 is a flowchart illustrating an example of operation execution according to the second embodiment;

FIG. 12 is a flowchart illustrating an example of state restoration according to the second embodiment;

FIG. 13 illustrates an example of a state transition graph according to the second embodiment;

FIG. 14 is a flowchart illustrating an example of determining a deletion target according to the second embodiment;

FIG. 15 illustrates an example of deletion target determination according to the second embodiment;

FIG. 16 illustrates another example of the GUI according to the second embodiment;

FIG. 17 illustrates an example of a snapshot record table according to a third embodiment;

FIG. 18 illustrates an example of a GUI according to the third embodiment;

FIG. 19 is a flowchart illustrating an example of determining a deletion target according to the third embodiment;

FIG. 20 illustrates a first example of a state transition graph according to the third embodiment;

FIG. 21 illustrates a first example of deletion target determination according to the third embodiment;

FIG. 22 illustrates a second example of the state transition graph according to the third embodiment; and

FIG. 23 illustrates a second example of the deletion target determination according to the third embodiment.

### DESCRIPTION OF EMBODIMENTS

Several embodiments will be described below with reference to the accompanying drawings, wherein like reference numerals refer to like elements throughout.

### (a) First Embodiment

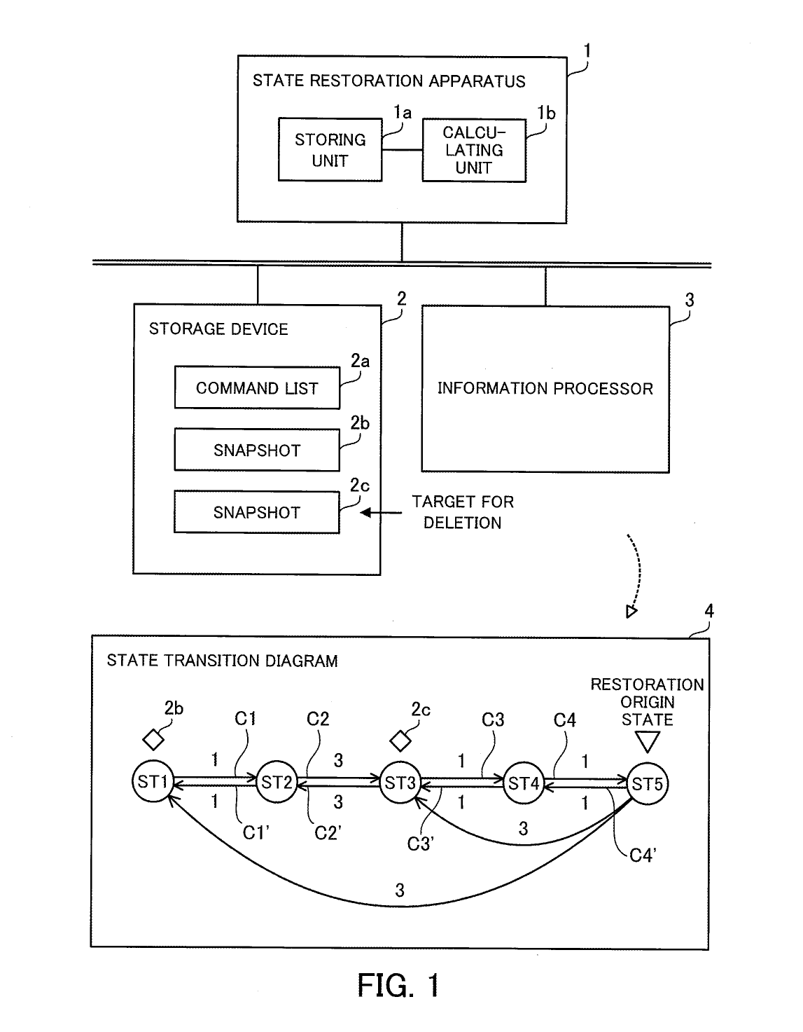

FIG. 1 illustrates a state restoration apparatus according to a first embodiment. A state restoration apparatus 1 restores a state of an information processor 3 using setting change commands and snapshots stored in a storage device 2. The state restoration apparatus 1 includes a storing unit 1a and a calculating unit 1b. The storing unit 1a may be a volatile storage device such as random access memory (RAM), or a non-volatile storage device such as a hard disk drive (HDD) or flash memory. The calculating unit 1b may include, for example, a central processing unit (CPU), a digital signal processor (DSP), an application specific integrated circuit (ASIC), and a field programmable gate array (FPGA). The calculating unit 1b may be a processor executing programs. The term “processor” here includes a set of multiple processors (i.e., multiprocessor).

The storing unit 1a stores therein information indicating the chronological order of a plurality of states of a restoration target apparatus. For example, with setting changes, the state of the information processor 3 has been transitioned in the following order: states ST1, ST2, ST3, ST4, and ST5. For example, the storing unit 1a stores information indicating the chronological order of the states ST1, ST2, ST3, ST4, and ST5.

Note that a state transition diagram 4 illustrates this state transition. In the state transition diagram 4, a symbol denoting a state (e.g., ST1) is placed in each circle. The right-pointing arrows connecting the circles represent forward transitions. The left-pointing arrows connecting the circles represent backward transitions. A symbol attached to each of the arrows (e.g., C1) represents a command causing a transition corresponding to the arrow. That is, commands causing the forward transitions are: a command C1 (from the state ST1 to the state ST2); a command C2 (from the state ST2 to the state ST3); a command C3 (from the state ST3 to the state ST4); and a command C4 (from the state ST4 to the state ST5). On the other hand, commands causing the backward transitions are: a command C4′ (from the state ST5 to the state ST4); a command C3′ (from the state ST4 to the state ST3); a command C2′ (from the state ST3 to the state ST2); and a command C1′ (from the state ST2 to the state ST1).

These individual commands are stored, for example, in a command list 2a of the storage device 2. Note however that the state restoration apparatus 1 may store the command list 2a instead. The individual commands are command statements written, for example, in predetermined shell scripts, programming languages, and structured query languages (SQL).

The storing unit 1a stores therein information indicating the amount of time needed to execute each of a plurality of commands, causing a forward or backward transition between two states. For example, the amount of time needed to execute each of the commands above is as follows: the command C1 takes 1; the command C2 takes 3; the command C3 takes 1; the command C4 takes 1; the command C4′ takes 1; the command C3′ takes 1; the command C2′ takes 3; and the command C1′ takes 1. In the state transition diagram 4, the numerical number given above each of the right-pointing arrows indicates the amount of time needed to execute the corresponding command causing the forward transition between the states. Similarly, the numerical number given below each of the left-pointing arrows indicates the amount of time needed to execute the corresponding command causing the backward transition between the states.

The storing unit 1a stores therein information indicating the amount of time needed for restoration to, among a plurality of states, each state for which a snapshot has been taken, using the snapshot. For example, a snapshot 2b has been taken for the state ST1, and a snapshot 2c has been taken for the state ST3. For example, the amount of time needed for restoration to the state ST1 using the snapshot 2b is 3. The amount of time needed for restoration to the state ST3 using the snapshot 2c is 3.

In the state transition diagram 4, the curved arrows denote the state transitions using the individual snapshots 2b and 2c. The numerical number given above each of the curved arrows indicates the amount of time needed for restoration using the corresponding snapshot. The snapshots 2b and 2c are stored, for example, in the storage device 2. Note however that the state restoration apparatus 1 may store the snapshots 2b and 2c instead.

Based on the information stored in the storing unit 1a, the calculating unit 1b calculates the shortest operation path to restore an apparatus from a restoration origin state to each of other states. For example, any state of the information processor 3 may be selected as its restoration origin state. The restoration origin state may be the current state of the information processor 3. If, for example, the restoration origin state is the state ST5, the calculating unit 1b calculates the shortest operation path to restore the information processor 3 from the state ST5 to each of the states ST1, ST2, ST3, and ST4 having taken place prior to the state ST5. The following describes specific examples. Note that the following enumerates, amongst infinite restoration paths, only restoration paths not going through the same state more than once as restoration path options.

Restoration path options from the state ST5 to the state ST1 are as follows: [a1] a path using the commands C4′, C3′, C2′, and C1′ (the amount of time needed is 6); [a2] a path using the snapshot 2c and the commands C2′ and C1′ (the amount of time needed is 7); and [a3] a path using the snapshot 2b (the amount of time needed is 3). Therefore, the path [a3] is the shortest operation path from the state ST5 to the state ST1.

Restoration path options from the state ST5 to the state ST2 are as follows: [b1] a path using the commands C4′, C3′, and C2′ (the amount of time needed is 5); [b2] a path using the snapshot 2c and the command C2′ (the amount of time needed is 6); and [b3] a path using the snapshot 2b and the command C1 (the amount of time needed is 4). Therefore, the path [b3] is the shortest operation path from the state ST5 to the state ST2.

Restoration path options from the state ST5 to the state ST3 are as follows: [c1] a path using the commands C4′ and C3′ (the amount of time needed is 2); [c2] a path using the snapshot 2c (the amount of time needed is 3); and [c3] a path using the snapshot 2b and the commands C1 and C2 (the amount of time needed is 7). Therefore, the path [c1] is the shortest operation path from the state ST5 to the state ST3.

Restoration path options from the state ST5 to the state ST4 are as follows: [d1] a path using the command C4′ (the amount of time needed is 1); [d2] a path using the snapshot 2c and the command C3 (the amount of time needed is 4); and [d3] a path using the snapshot 2b and the commands C1, C2, and C3 (the amount of time needed is 8). Therefore, the path [d1] is the shortest operation path from the state ST5 to the state ST4.

The calculating unit 1b may employ, for example, Dijkstra's algorithm, to search for the shortest operation paths. For example, the state transition diagram 4 is represented as a graph with nodes corresponding to the states and edges corresponding to the arrows indicating the transitions between two states. By applying Dijkstra's algorithm to the graph, the calculating unit 1b is able to calculate the shortest operation path from the restoration origin state ST5 to each of the states ST1, ST2, ST3, and ST4 having taken place prior to the state ST5.

The calculating unit 1b determines each snapshot not included in any of the shortest operation paths as a target for deletion. According to the above-described example with the shortest operation paths obtained for the restoration origin state ST5, the snapshot 2b is used in the shortest operation paths for the restoration to the states ST1 and ST2. On the other hand, the snapshot 2c is not used in any of the shortest operation paths. Therefore, the calculating unit 1b determines the snapshot 2c as a deletion target. Subsequently, the calculating unit 1b may control the snapshot 2c to be deleted from the storage device 2.

According to the state restoration apparatus 1, the calculating unit 1b calculates, based on the information stored in the storing unit 1a, the shortest operation path to restore the information processor 3 from its restoration origin state to each of other states. Then, the calculating unit 1b determines each snapshot not used in any of the shortest operation paths as a deletion target.

Herewith, it is possible to save storage space while speeding up restoration. Note that a snapshot is taken for each predetermined unit (for example, individual virtual machines and databases) in the information processor 3 at a particular point in time. For this reason, the data size of each snapshot is larger than that of the command list 2a. Therefore, increased numbers of snapshots put pressure on the space of the storage device 2. The storage space could be saved by deleting snapshots, which, however, makes the deleted snapshots unavailable for restoration. This may result in an increased amount of time needed for restoration to a particular state.

According to the example of the state transition diagram 4, restoration using each of the snapshots 2b and 2c is implemented by image application, and therefore the restoration is likely to finish within a predetermined time frame. On the other hand, the amount of time needed for its execution varies among the commands C1 to C4 and C1′ to C4′. That is, the execution of each of the commands C1, C3, C4, C1′, C3′, and C4′ takes a relatively short time while the execution of each of the commands C2 and C2′ takes a relatively long time. If the snapshot 2b is deleted, the shortest operation paths (the paths [a3] and [b3] above) become unavailable for restoration from the state ST5 to the states ST1 and ST2. Therefore, determining a deletion target in such a manner as to delete the oldest snapshot may result in a longer restoration time than before the snapshot being deleted.

In view of this, based on information on the amount of time needed for restoration to each state using individual commands and snapshots, the calculating unit 1b determines, as a deletion target, each snapshot not used in any of the shortest operation paths from a restoration origin state to other individual states. This is because keeping snapshots not contributing to speeding up restoration is ineffectual. That is, according to the first embodiment, the snapshot 2b used in one or more shortest operation paths is left undeleted, and the snapshot 2c not used in any shortest operation path is deleted. Herewith, it is possible to save storage space while speeding up restoration.

Note that the calculating unit 1b may measure in advance the amount of time needed for restoration to each state using individual commands and snapshots by employing the command list 2a and the snapshots 2b and 2c stored in the storage device 2, and then store the measured amount of time in the storing unit 1a. Alternatively, a user may be allowed to input the amount of time needed for restoration to each state using individual commands and snapshots. In addition, each command may be a permutation of a plurality of subcommands. For example, the command C1 is a command group for sequentially executing a plurality of subcommands.

### (b) Second Embodiment

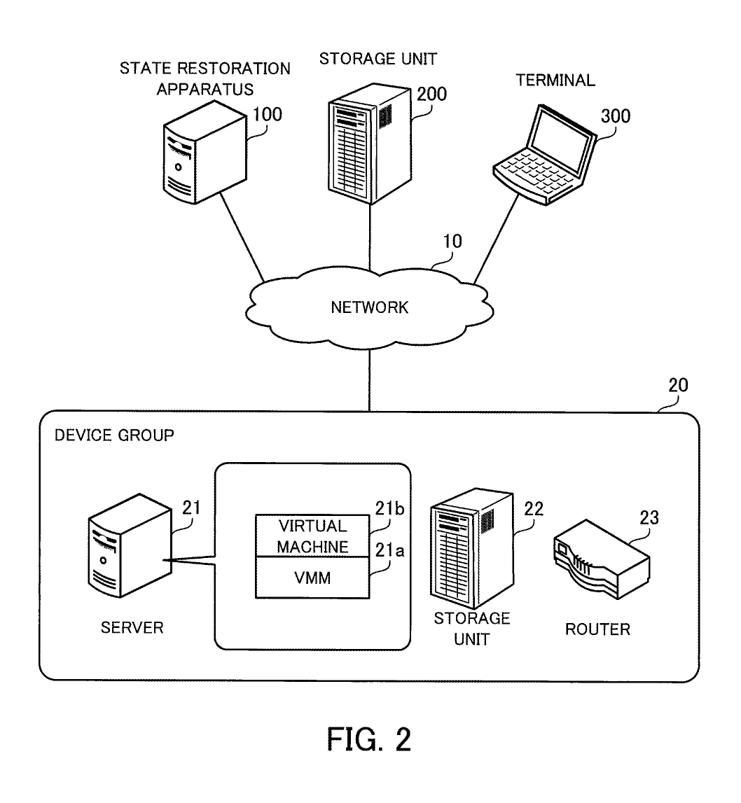

FIG. 2 illustrates an information processing system according to a second embodiment. The information processing system of the second embodiment includes a device group 20, a state restoration apparatus 100, a storage unit 200, and a terminal 300. The device group 20, the state restoration apparatus 100, the storage unit 200, and the terminal 300 are all connected to a network 10. The network 10 may be a local area network (LAN), or a broad area network such as a wide area network (WAN) or the Internet. The device group 20 includes a server 21, a storage unit 22, and a router 23.

The server 21 is a physical computer to run a virtual machine monitor (VMM) 21a to thereby implement a virtual machine 21b. A physical computer like the server 21 is sometimes called the physical machine. The server 21 is able to deploy a plurality of virtual machines 21b. The VMM 21a is software for managing virtual machines. The VMM 21a allocates processing power of a CPU and a storage area of RAM in the server 21 to the virtual machine 21b as computational resources. The VMM 21a is sometimes called a hypervisor. The virtual machine 21b is a virtual computer running on the server 21. The virtual machine 21b is able to run software, such as an operating system (OS) and predetermined applications. In the following description, when the term “device” is used, it refers to both physical and virtual machines.

The storage unit 22 is a storage device for storing various types of data to be used in processing of the software running on the virtual machine 21b. The router 23 is a relay device for connecting various types of devices included in the device group 20 to thereby relay communication.

For example, in the information processing system of the second embodiment, the device group 20 is installed in a data center, and functions and computational resources implemented by the device group 20 are provided to external users. Such computer utilization is sometimes called cloud computing. Settings on each device of the device group 20 may be changed according to changes in contents, such as resources, to be provided to external users. For example, with shifts in the number of devices and virtual machines, changes are made to settings for communication and software operating environments. In such a case, a user managing the information processing system makes updating for each change (sometimes referred to as the “release work”). With the release work, the state of each device of the device group 20 changes.

The state restoration apparatus 100 is a server computer for providing a function of restoring each device included in the device group 20 to its state at a predetermine time point in the past. The state restoration apparatus 100 manages states of each device by associating each of the states, for example, with the time when the device was in the state, and restores each device to its state at a particular point in time. Note that because the virtual machine 21b runs on the server 21, the state of the virtual machine 21b may be seen as the state of the server 21. In addition, a change in the state of the virtual machine 21b may be seen as a change in the state of the server 21.

The storage unit 200 stores therein backup data for each device included in the device group 20. Acquisition of backup data allows all or some of the devices in the device group 20 to be restored to their states at the time when the backup data was acquired. The backup data includes, for example, snapshots of the server 21 and the virtual machine 21b and configuration data (for example, setting contents described in text) of the storage unit 22 and the router 23.

For example, the operating system or a predetermined application of the server 21 takes a snapshot of a predetermined storage area of the server 21 at a predetermined timing, and then stores the snapshot in the storage unit 200. In addition, for example, the VMM 21a takes a memory/disk image of the virtual machine 21b as a snapshot at a predetermined timing, and then stores it in the storage unit 200. The predetermined timing may be periodical, or may be a timing designated by the user.

The terminal 300 is a client computer operated by the user. The terminal 300 provides the user with a predetermined graphical user interface (GUI). The terminal 300 transmits a request corresponding to an operation made on the GUI to the state restoration apparatus 100. For example, the terminal 300 causes the state restoration apparatus 100 to implement restoration while designating a state of each device (or each collection of devices) of the device group 20, desired to be restored.

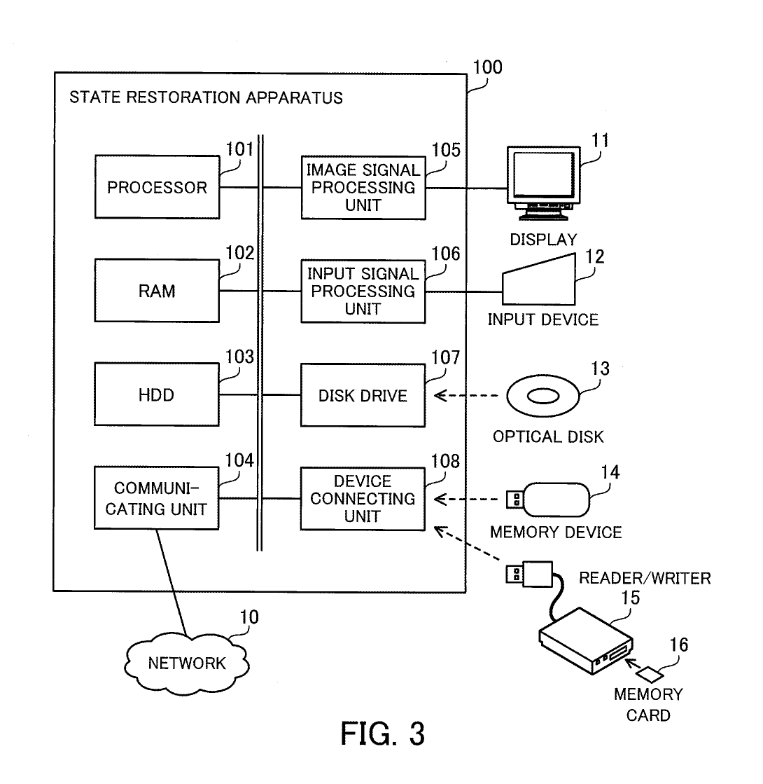

FIG. 3 illustrates an example of hardware of the state restoration apparatus according to the second embodiment. The state restoration apparatus 100 includes a processor 101, RAM 102, a HDD 103, a communicating unit 104, an image signal processing unit 105, an input signal processing unit 106, a disk drive 107, and a device connecting unit 108. The individual units are connected to a bus of the state restoration apparatus 100. The server and the terminal 300 may individually be implemented using the same hardware components as the state restoration apparatus 100.

The processor 101 controls information processing of the state restoration apparatus 100. The processor 101 may be a multi-processor. The processor 101 is, for example, a CPU, a DSP, an ASIC, a FPGA, or a combination of two or more of these. The RAM 102 is used as the main storage device of the state restoration apparatus 100. The RAM 102 temporarily stores at least part of an operating system (OS) program and application programs to be executed by the processor 101. The RAM 102 also stores therein various types of data to be used by the processor 101 for its processing.

The HDD 103 is a secondary storage device of the state restoration apparatus 100, and magnetically writes and reads data to and from a built-in magnetic disk. The HDD 103 stores therein the OS program, application programs, and various types of data. Instead of the HDD 103, the state restoration apparatus 100 may be provided with a different type of secondary storage device such as flash memory or a solid state drive (SSD), or may be provided with a plurality of secondary storage devices. Note that the storage unit 200 is also provided with a plurality of storage devices, such as a HDD and a SDD.

The communicating unit 104 is an interface for communicating with other computers via the network 10. The communicating unit 104 may be a wired or wireless interface. The image signal processing unit 105 outputs an image to a display 11 connected to the state restoration apparatus 100 according to an instruction from the processor 101. A cathode ray tube (CRT) display or a liquid crystal display, for example, may be used as the display 11. The input signal processing unit 106 acquires an input signal from an input device 12 connected to the state restoration apparatus 100, and outputs the signal to the processor 101. A pointing device, such as a mouse or a touch panel, or a keyboard may be used as the input device 12.

The disk drive 107 is a drive unit for reading programs and data recorded on an optical disk 13 using, for example, laser light. Examples of the optical disk 13 include a digital versatile disc (DVD), a DVD-RAM, a compact disk read only memory (CD-ROM), a CD recordable (CD-R), and a CD-rewritable (CD-RW). The disk drive 107 stores programs and data read from the optical disk 13 in the RAM 102 or the HDD 103 according to an instruction from the processor 101.

The device connecting unit 108 is a communication interface for connecting peripherals to the state restoration apparatus 100. To the device connecting unit 108, for example, a memory device 14 and a reader/writer 15 may be connected. The memory device 14 is a storage medium having a function for communicating with the device connecting unit 108. The reader/writer 15 is a device for writing and reading data to and from a memory card 16 which is a card type storage medium. The device connecting unit 108 stores programs and data read from the memory device 14 or the memory card 16 in the RAM 102 or the HDD 103, for example, according to an instruction from the processor 101.

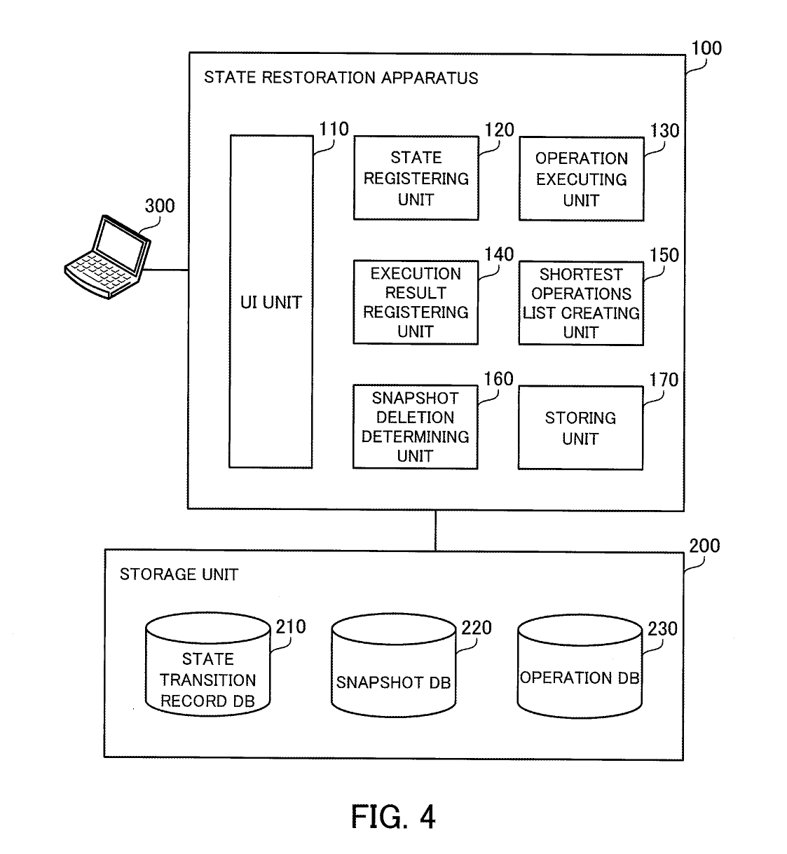

FIG. 4 illustrates an example of functions of the state restoration apparatus according to the second embodiment. The state restoration apparatus 100 includes a user interface (UI) unit 110, a state registering unit 120, an operation executing unit 130, an execution result registering unit 140, a shortest operations list creating unit 150, a snapshot deletion determining unit 160, and a storing unit 170. The user interface unit 110, the state registering unit 120, the operation executing unit 130, the execution result registering unit 140, the shortest operations list creating unit 150, and the snapshot deletion determining unit 160 may be implemented as modules of software executed by the processor 101. The storing unit 170 may be implemented as a storage area secured in the RAM 102 or the HDD 103.

The user interface unit 110 provides the terminal 300 with a GUI. The user interface unit 110 receives an operational input on the GUI. According to the received input, the user interface unit 110 instructs each unit of the state restoration apparatus 100 to execute processing. The state registering unit 120 records a state of each device. The state of each device may be changed according to setting changes associated with release work. The state registering unit 120 generates information for identifying the state of each device at a particular point in time (for example, the time), and stores the information in the storage unit 200. In addition, the state registering unit 120 causes the server 21 to take a snapshot at a predetermined timing.

The operation executing unit 130 controls the execution of a setting change operation. Here, the term “operation” refers to a collection of setting change commands. A single command may correspond to one operation, or a plurality of commands (a command group) may correspond to one operation. The operation executing unit 130 reads, from the storage unit 200, one or more operations associated with release work, and causes an operation target device to sequentially execute the operations. The operation executing unit 130 also controls the execution of state restoration operations.

The execution result registering unit 140 records a state transition of each device according to the execution of an operation. The execution result registering unit 140 generates information indicating a state transition according to an operation with respect to each device, and stores the information in the storage unit 200. The execution result registering unit 140 stores, in the storage unit 200, an operation data piece indicating the details of the executed operation.

The shortest operations list creating unit 150 combines operations for state restoration of a device (restoration operations) to thereby create a group of restoration operations taking the shortest amount of time from a restoration-source state to a restoration-target state (a shortest operations list). Note that the term “restoration operation” here includes an operation executed by the operation executing unit 130 and a state restoration operation for configuring settings opposite to those set by the operation executed by the operation executing unit 130 (the operation for configuring the opposite settings is hereinafter referred to as the “fallback operation”). The term “restoration operation” also includes a state restoration operation using a snapshot.

The snapshot deletion determining unit 160 determines a snapshot to be deleted amongst snapshots stored in the storage unit 200 based on shortest operations lists created by the shortest operations list creating unit 150. The snapshot deletion determining unit 160 then deletes the deletion-target snapshot from the storage unit 200. The storage unit 170 stores therein various types of information to be used by the individual units of the state restoration apparatus 100 for their processing. For example, the storing unit 170 stores a replication of at least a part of the various types of information stored in the storage unit 200, and provides the replication to the individual units of the state restoration apparatus 100.

The storage unit 200 stores therein a state transition record database (DB) 210, a snapshot database 220, and an operation database 230. The state transition record database 210, the snapshot database 220, and the operation database 230 may be implemented as storage areas secured in a storage device of the storage unit 200. The state transition record database 210 stores therein information indicating states of devices, created by the state registering unit 120, and information indicating state transitions of the devices, created by the execution result registering unit 140. The snapshot database 220 stores therein snapshots taken for the individual devices and information indicating mappings between the snapshots and individual states. The operation database 230 stores therein operation data pieces of operations executed by the operation executing unit 130. Note that at least one of the state transition record database 210, the snapshot database 220, and the operation database 230 may be stored in the state restoration apparatus 100.

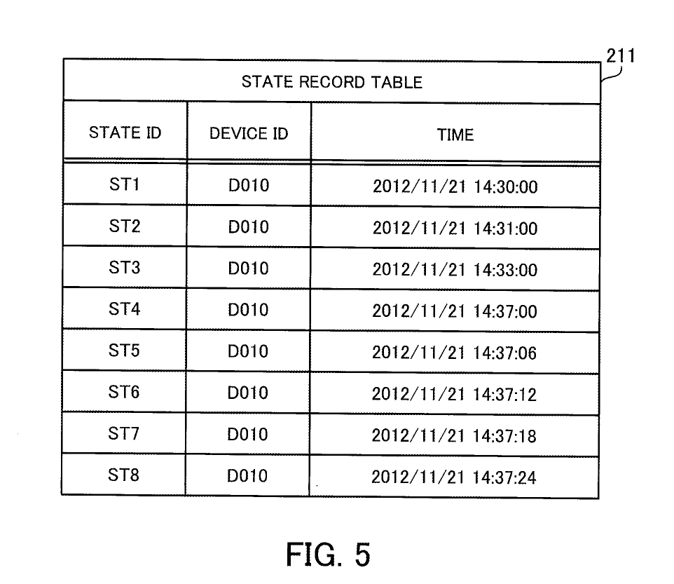

FIG. 5 illustrates an example of a state record table according to the second embodiment. A state record table 211 is information with states of each device recorded. The state record table 211 is stored in the state transition record database 210. The state record table 211 includes columns of the following items: state identifier (ID); device identifier; and time.

Each field in the state identifier column contains the state identifier for identifying a state. Each field in the device identifier contains the device identifier for identifying a device. In the case where the device identifier indicates a virtual machine, the device identifier also identifies a physical machine that runs the virtual machine. Each field in the time column contains the time. Note that, according to the second embodiment, a state of a device at a particular point in time is expressed, by way of example, as the time indicating the specific point in time. Note however that it may be recorded by a different method.

For example, a record with “ST1” in the state identifier column; “D010” in the device identifier column; and “2012/11/21 14:30:00” in the time column is registered in the state record table 211. This record indicates that a state identified by the state identifier “ST1” of a device with the device identifier “D010” is the state obtained on Nov. 21, 2012 at 14:30:00. Note here that the device identifier “D010” is the device identifier of the virtual machine 21b. “D” in “D010” indicates the server 21, and “010” indicates the virtual machine 21b. In the following, the state identified by a particular state identifier is sometimes denoted as, for example, “state ST1”.

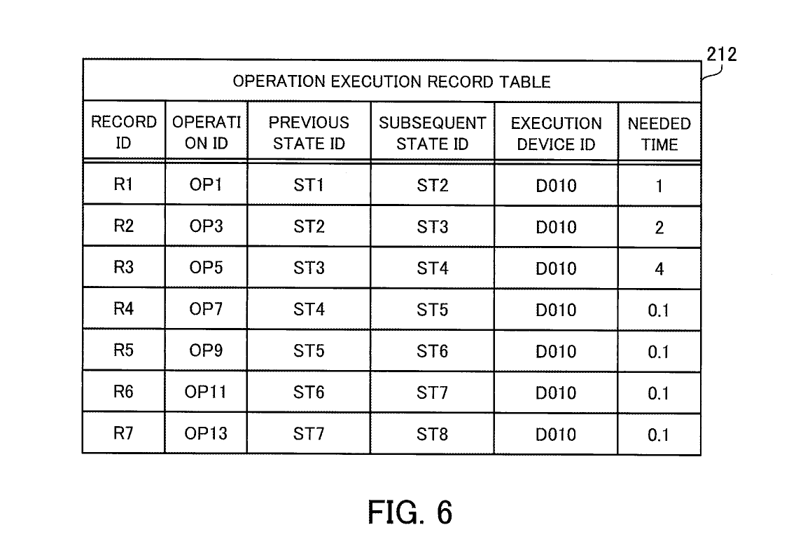

FIG. 6 illustrates an example of an operation execution record table according to the second embodiment. An operation execution record table 212 is information indicating state transitions according to executed operations. The operation execution record table 212 is stored in the state transition record database 210. The operation execution record table 212 includes columns of the following items: record identifier, operation identifier, previous state identifier, subsequent state identifier, execution device identifier, and needed time.

Each field in the record identifier column contains the record identifier for identifying a record. Each field in the operation identifier column contains the operation identifier for identifying an operation. Each field in the previous state identifier column contains the identifier of a state just before the execution of the corresponding operation. Each field in the subsequent state identifier column contains the identifier of a state immediately following the execution of the corresponding operation. Each field in the execution device identifier column contains the identifier of a device having executed the corresponding operation. Each field in the needed time column contains the amount of time needed to execute the corresponding operation. Note here that the needed time is in minutes, for example (the same shall apply hereinafter).

For example, a record with “R1” in the record identifier column; “OP1” in the operation identifier column; “ST1” in the previous state identifier column; “ST2” in the subsequent state identifier column; “D010” in the execution device identifier column; and “1 (min)” in the needed time column is registered in the operation execution record table 212. This record indicates that an operation identified by the operation identifier “OP1” was executed on a device with the device identifier “D010” in the state ST1, which caused the state of the device to transition to the state ST2. The record also indicates that the operation took 1 minute to be executed. Further, the record indicates that it is identified by the record identifier “R1”. In the following, the operation identified by a particular operation identifier is sometimes denoted as, for example, “operation OP1”.

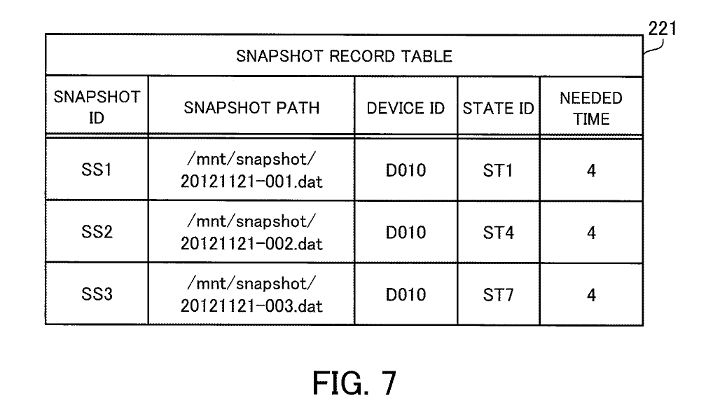

FIG. 7 illustrates an example of a snapshot record table according to the second embodiment. A snapshot record table 221 is information for managing snapshots. The snapshot record table 221 is stored in the snapshot database 220. The snapshot record table 221 includes columns of the following items: snapshot identifier; snapshot path; device identifier; state identifier; and needed time.

Each field in the snapshot identifier column contains the snapshot identifier of a snapshot. Each field in the snapshot path column contains the pointer indicating the location of the corresponding snapshot. Each field in the device identifier column contains the device identifier of a device for which the corresponding snapshot was taken. Each field in the state identifier column contains the state identifier corresponding to a state at a time when the corresponding snapshot was taken. Each field in the needed time column contains the amount of time needed to restore the state using the corresponding snapshot.

For example, a record with “SS1” in the snapshot identifier column; “/mnt/snapshot/20121121-001.dat” in the snapshot path column; “D010” in the device identifier column; “ST1” in the state identifier column; and “4 (min)” in the needed time column is registered in the snapshot record table 221. This record indicates that a snapshot with the snapshot identifier “SS1” and the snapshot path “/mnt/snapshot/20121121-001.dat” has been taken for a device identified by the device identifier “D010”. The record also indicates that the snapshot corresponds to the state ST1 of the device, and that state restoration using the snapshot takes 4 minutes. In the following, the snapshot identified by a particular snapshot identifier is sometimes denoted as, for example, “snapshot SS1”.

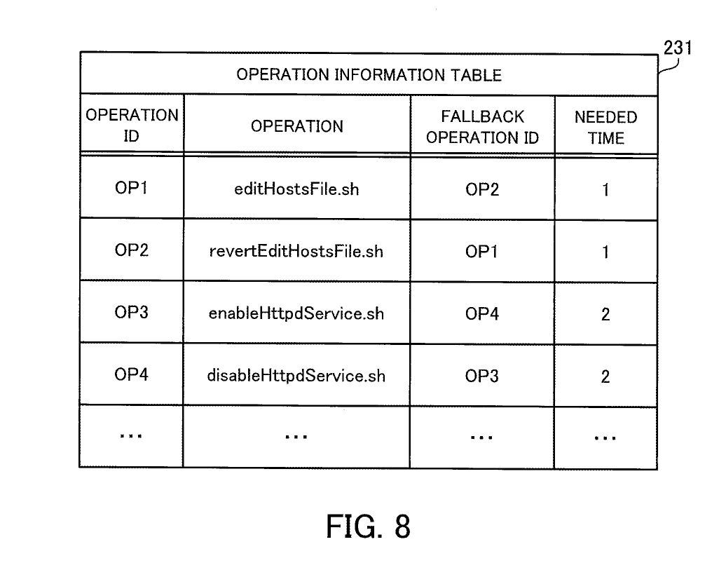

FIG. 8 illustrates an example of an operation information table according to the second embodiment. An operation information table 231 is information for managing operation data pieces. The operation information table 231 is stored in the operation database 230. The operation information table 231 includes columns of the following items: operation identifier; operation; fallback operation identifier; and needed time.

Each field in the operation identifier column contains the operation identifier of an operation. Each field in the operation column contains the operation data piece of the corresponding operation. Each field in the fallback operation identifier column contains the operation identifier of a fallback operation associated with the corresponding operation. Each field in the needed time column contains the amount of time needed to execute the corresponding operation.

For example, a record with “OP1” in the operation identifier column; “editHostsFile.sh” in the operation column; “OP2” in the fallback operation identifier column; and “1 (min)” in the needed time column is registered in the operation information table 231. This record indicates that an operation with a file name of “editHostsFile.sh” has the operation identifier “OP1”, and that a fallback operation for restoring settings configured by the operation OP1 to its original state is the operation OP2. The record also indicates that the operation OP1 takes 1 minute to be executed.

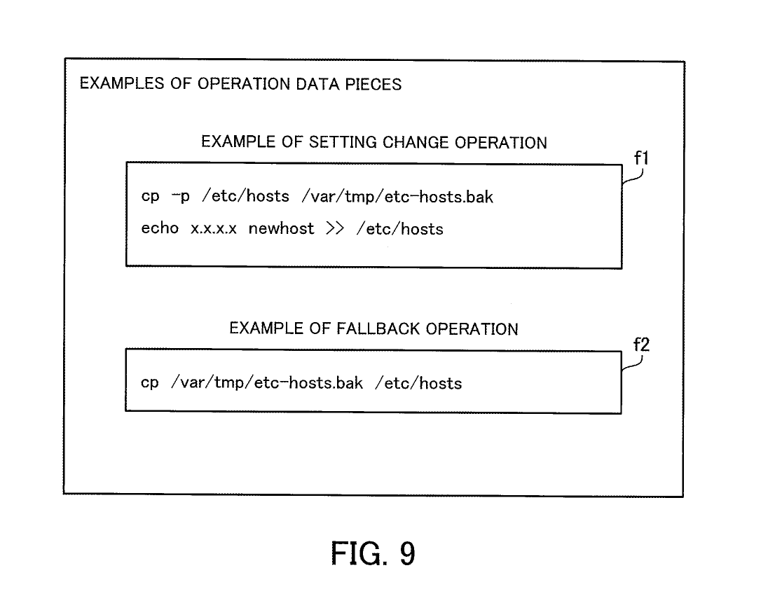

FIG. 9 illustrates examples of operation data pieces according to the second embodiment. Operation data pieces f1 and f2 illustrate a case where commands are written using shell scripts. The operation data piece f1 is an example of an operation of adding a record “x.x.x.x newhost” to a file “hosts”. In the operation data piece f1, with a cp command, a copy of the file “hosts” before the change is made and a file name “etc-hosts.bak” is assigned to the copy. Subsequently, with an echo command, the record above is added to the file “hosts”. That is, the operation data piece f1 includes two commands.

The operation data piece f2 is an example of an operation of restoring the file “hosts” to its original state before the change. In the operation data piece f2, with a cp command, the content of the file “etc-hosts.bak” is overwritten to the file “hosts”. This operation is a fallback operation corresponding to the operation indicated by the operation data piece f1. The operation data piece f2 includes one command. Note that the form of the operation data pieces f1 and f2 is not limited to shell scripts, and various types of forms (for example, programs written in predetermined programming languages) may be used.

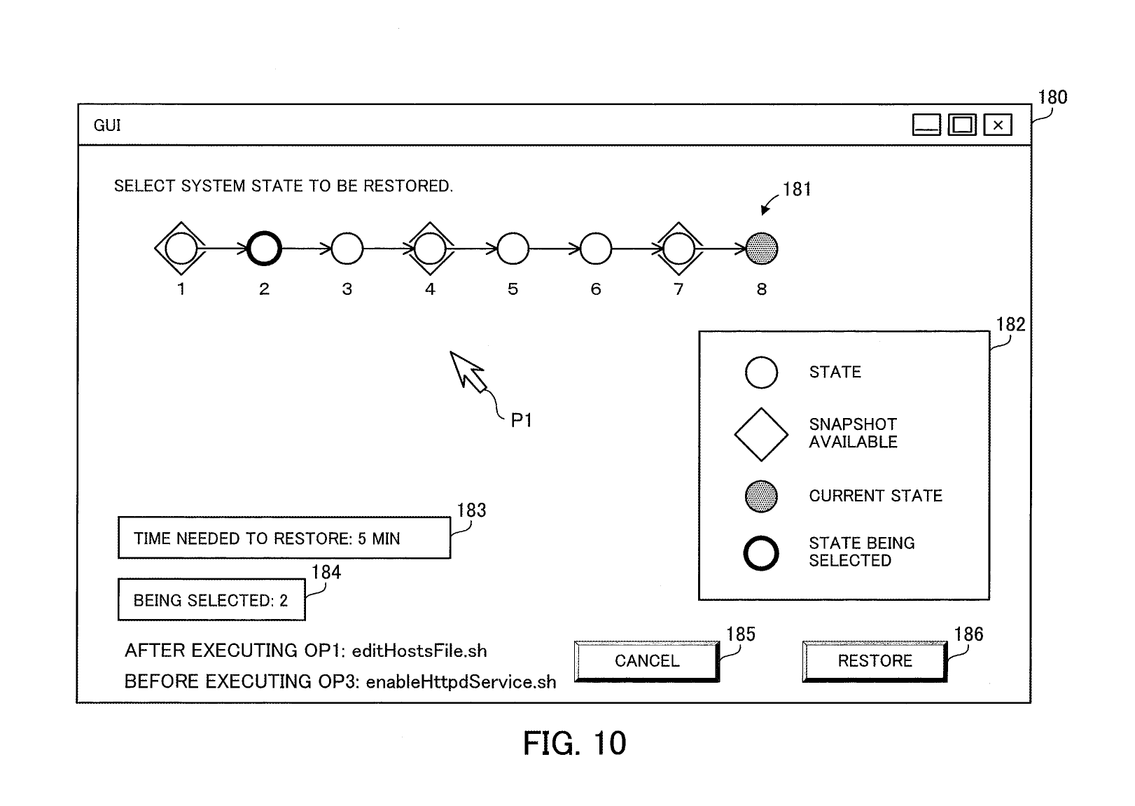

FIG. 10 illustrates an example of a GUI according to the second embodiment. A GUI 180 is a user interface for supporting a user to make inputs for state restoration. The GUI 180 is generated by the user interface unit 110 based on information stored in the storage unit 200 and then provided for the terminal 300. The GUI 180 includes a state transition diagram 181, a legend 182, a needed time display form 183, a selected state display form 184, a cancel button 185, and a restore button 186.

The state transition diagram 181 is an image of state transitions of the device identified by the device identifier “D010”, represented based on the operation information table 231, the operation execution record table 212, and the snapshot record table 221. The legend 182 explains what each symbol used in the state transition diagram 181 means. In the state transition diagram 181, individual states are graphically represented according to keys listed in the legend 182.

For example, a single circle represents one state. A circle in a square represents a state for which a snapshot has been taken. A shaded circle (darker than other circles) represents a current state of the device. A circle with a thicker line than others represents a state currently selected by the user (i.e., a state being a restoration-target option). For example, the user controls a pointer P1 using an input device provided with the terminal 300 and selects one of the circles displayed in the state transition diagram 181, to thereby select a state to be a restoration-target option.

The needed time display form 183 displays approximate time needed to restore the device from the current state to the state being selected. Note that, as described later, the needed time display form 183 displays the shortest time needed for the restoration. The selected state display form 184 displays a state currently selected by the user. For example, in the state transition diagram 181, the state ST2 is displayed in association with a number “2”. When a circle corresponding to the state ST2 is selected, the selected state display form 184 displays that the state “2” is being selected. In addition, details regarding the state being selected are displayed below the selected state display form 184. For example, the details indicate that the state ST2 is a state obtained after the execution of the operation OP1. The details also indicate that the state ST2 is a state obtained before the execution of the operation OP3.

The cancel button 185 is a button to terminate the display of the GUI 180. The restore button 186 is a button to instruct the state restoration device 100 to make restoration to the state being selected. For example, the user controls the pointer P1 using an input device provided with the terminal 300 to thereby press the cancel button 185 or the restore button 186. The terminal 300 transmits an instruction corresponding to the pressed button to the state restoration apparatus 100.

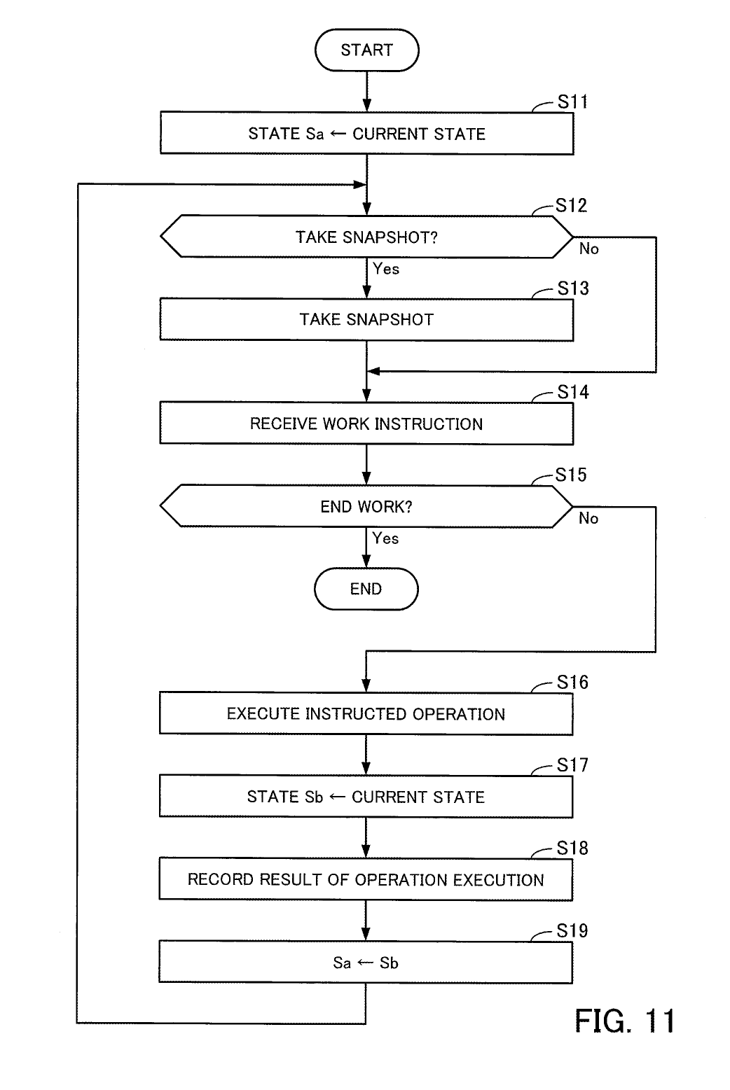

FIG. 11 is a flowchart illustrating an example of operation execution according to the second embodiment. The process of FIG. 11 is described next according to the step numbers in the flowchart. Note that the following describes a case in which the virtual machine 21b is the target of release work; however, a similar procedure is also applicable to perform release work on other devices.

[Step S11] The user interface unit 110 receives an instruction to start release work on the virtual machine 21b. For example, the user operates the terminal 300 to input the release work start instruction to the state restoration apparatus 100. The user interface unit 110 causes the individual units of the state restoration apparatus 100 to perform the following processing. First, the state registering unit 120 records, in the state record table 211, information indicating a state at the start of the release work (the current time). According to the state record table 211, the state at the start of the release work corresponds to the state ST1. The state registering unit 120 assigns the state identifier (for example, “ST1”) of the state of the server 21 to a state-indicating variable Sa.

[Step S12] The state registering unit 120 determines whether to take a snapshot of the virtual machine 21b. In the case of taking a snapshot, the process moves to step S13. In the case of not taking a snapshot, the process moves to step S14. As described above, a snapshot is taken periodically, or at a timing designated by the user. For example, the state registering unit 120 may determine to take a snapshot each time a predetermined amount of time elapses, or each time a predetermined number of operations are executed. Otherwise, the state registering unit 120 determines not to take a snapshot.

[Step S13] The state registering unit 120 instructs the VMM 21a to take a snapshot of the virtual machine 21b. The VMM 21a takes a snapshot of the virtual machine 21b and then stores it in the storage unit 200. The server 21 notifies the state restoration apparatus 100 of the acquisition of the snapshot. The state registering unit 120 assigns a snapshot identifier to the newly created snapshot. The state registering unit 120 registers, in the snapshot record table 221, the snapshot identifier and a path of the snapshot in association with the state indicated by the variable Sa. Note that because the amount of time needed for restoration using a snapshot is considered to be approximately constant, a predetermined value or a value predicted by past performance (4 minutes in the example of the snapshot record table 221) is registered. The state registering unit 120 also registers the device identifier of the virtual machine 21b (for example, “D010”) in the device identifier column of the snapshot record table 221.

[Step S14] The operation executing unit 130 receives a work instruction. For example, the user operates the terminal 300 and inputs a new shell script file (for example, “editHostsFile.sh”), to thereby instruct the state restoration apparatus 100 to continue the release work. Alternatively, the user operates the terminal 300 to instruct the state restoration apparatus 100 to end the release work (for example, “quit”). The operation executing unit 130 receives such an instruction via the user interface unit 110.

[Step S15] The operation executing unit 130 determines whether it has received a work end instruction. If a work end instruction has been received, the process ends. If the operation executing unit 130 has received not a work end instruction but an operation input, the process moves to step S16.

[Step S16] The operation executing unit 130 causes the virtual machine 21b to execute the input operation. The operation executing unit 130 measures the amount of time needed to execute the operation and records it in the storing unit 170.

[Step S17] Once the execution of the operation has been completed, the state registering unit 120 records information indicating the current state (the current time) in the state record table 211. For example, if the current state is a state following the state ST1, the state ST2 is newly recorded. The state registering unit 120 assigns the state identifier of the current state to a state-indicating variable Sb.

[Step S18] The execution result registering unit 140 records the result of the operation execution. Specifically, a record is registered in the operation execution record table 212 with the value of the variable Sa designated as the previous state identifier, the value of the variable Sb designated as the subsequent state identifier, and the identifier of the virtual machine 21b designated as the execution device identifier, in association with the operation identifier of the executed operation. In addition, the record is assigned a record identifier, and the time measured in step S16 is also registered as the needed time. Note that the operation identifier is obtained as follows. First, it is determined whether an operation with the same name as the input operation (for example, “editHostsFile.sh”) has already been registered in the operation information table 231. If it has already been registered, the operation identifier of the operation with the same name is extracted and used for the registration. If it has yet to be registered, a new operation identifier is assigned and then registered in the operation information table 231 (the time measured in step S16 is registered as the needed time). Subsequently, the newly assigned operation identifier is used in registering the result of the operation execution in the operation execution record table 212. As for the registration in the operation information table 231 at this point in time, a NULL value is registered as the fallback operation identifier (i.e., no fallback operation). Note however that the user may be allowed to input the fallback operation identifier and an operation data piece describing a corresponding fallback operation. If such inputs are received, the execution result registering unit 140 registers, in the operation information table 231, the input fallback operation identifier and operation data piece of the fallback operation.

[Step S19] The state registering unit 120 assigns the value of the state-indicating variable Sb to the variable Sa. Subsequently, the process moves to step S12.

In the above-described manner, the release work on the server 21, or the like, is performed by sequentially executing operations. Note that, in the above description, designation of each operation by the user is sequentially received; however, the method of sequentially executing operations is not limited to this. For example, a plurality of operations to be executed for release work and the execution order of the operations may be scheduled in advance. In this case, the operations are sequentially executed according to the scheduled procedure.

In step S12, the operation executing unit 130 may query the user about whether to take a snapshot. For example, if an input indicating to take a snapshot is received from the user, the operation executing unit 130 determines accordingly. On the other hand, if an input indicating not to take a snapshot is received, the operation executing unit 130 determines accordingly.

Further, even if a fallback operation identifier corresponding to the operation identifier registered in the operation information table 231 is not yet registered at the time of step S18, the user is allowed to register the fallback operation identifier later. In step S18 or later when a fallback operation data piece is input, the execution result registering unit 140 registers it in the operation information table 231, as described above. Then, the operation executing unit 130 measures in advance the amount of time needed for the fallback operation, for example, in a test environment using the fallback operation data piece. The execution result registering unit 140 registers the measured time of the fallback operation in the operation information table 231. Note however that, under the estimation that the time needed for the fallback operation is equal to the time needed for the corresponding forward operation, the same amount of time may simply be registered in the operation information table 231.

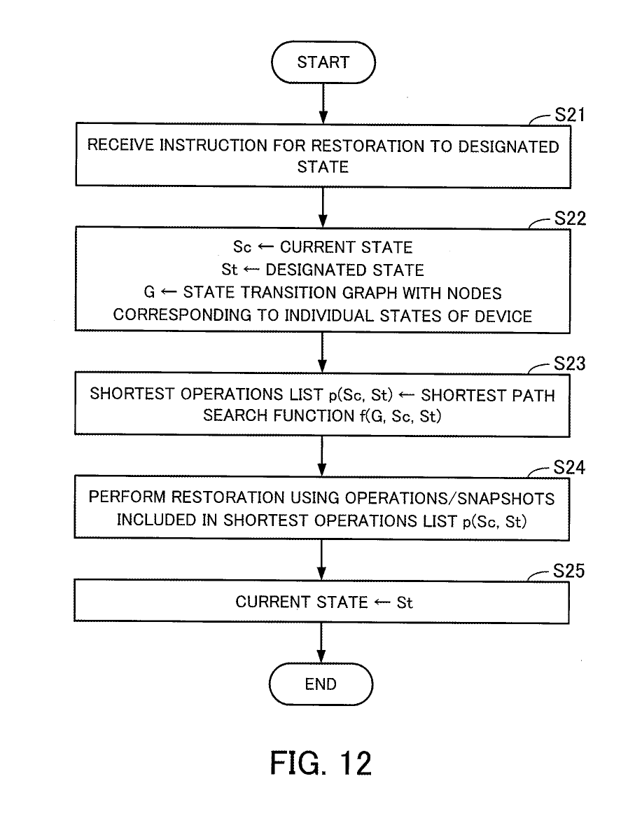

A state restoration method is illustrated next. A state restoration process is performed at any timing. FIG. 12 is a flowchart illustrating an example of state restoration according to the second embodiment. The process of FIG. 12 is described next according to the step numbers in the flowchart. Note that the following describes a case in which the virtual machine 21b is the target of the state restoration; however, similar operations are also applicable to perform state restoration on other devices.

[Step S21] The user interface unit 110 receives an instruction to restore the virtual machine 21b from the current state to a designated state. For example, the user is able to designate a restoration-target state using the GUI 180 and input, to the state restoration apparatus 100, an instruction to restore the virtual machine 21b to the restoration-target state. The user may use input means (for example, a command line interface (CLI)) other than the GUI 180. The user interface unit 110 causes the individual units of the state restoration apparatus 100 to perform the following processing.

[Step S22] The shortest operations list creating unit 150 assigns a state identifier of the current state of the virtual machine 21b to a variable Sc (in the following, the state identified, for example, by the variable Sc is sometimes denoted as “state Sc”). In addition, the shortest operations list creating unit 150 assigns a state identifier of the designated state to a variable St. Further, the shortest operations list creating unit 150 creates a state transition graph G with nodes corresponding to individual states and edges corresponding to transitions between two individual states. Each edge corresponds to a restoration operation using an operation data piece or a snapshot. The length of each edge corresponds to the amount of time needed for its corresponding restoration operation. For example, the state transition graph G is represented by an adjacency matrix, with each edge weighted according to the time needed to execute its corresponding operation data piece or the time needed for restoration using its corresponding snapshot.

[Step S23] The shortest operations list creating unit 150 produces a shortest operations list p(Sc, St) regarding a transition from the state Sc to the state St by using a shortest path search function f(G, Sc, St) with the state transition graph G and the variables Sc and St as variables. The shortest operations list p may include one or more restoration operations using a snapshot. For example, the function f employs Dijkstra's algorithm to produce, based on the state transition graph G, the shortest operations list p regarding a transition from the state Sc to the state St. Dijkstra's algorithm is an algorithm used to solve a shortest path problem in graph theory. The shortest operations list creating unit 150 provides the shortest operations list p for the operation executing unit 130.

[Step S24] The operation executing unit 130 causes the server 21 (and the virtual machine 21b) to sequentially execute restoration operations indicated by the shortest operations list p, to thereby restore the virtual machine 21b to the designated State St. In the case of performing restoration using a snapshot, the operation executing unit 130 instructs the VMM 21a to perform the restoration while designating the snapshot. In the case of performing restoration using shell scripts, the operation executing unit 130 instructs the virtual machine 21b to perform the restoration while designating the shell scripts.

[Step S25] The state registering unit 120 sets the state St obtained after the restoration as the current state of the server 21.

In the above-described manner, the operation executing unit 130 restores a state of a device using the shortest restoration operations. As a result, it is possible to speed up the restoration. Next described is calculation of a shortest operation path, using a specific example.

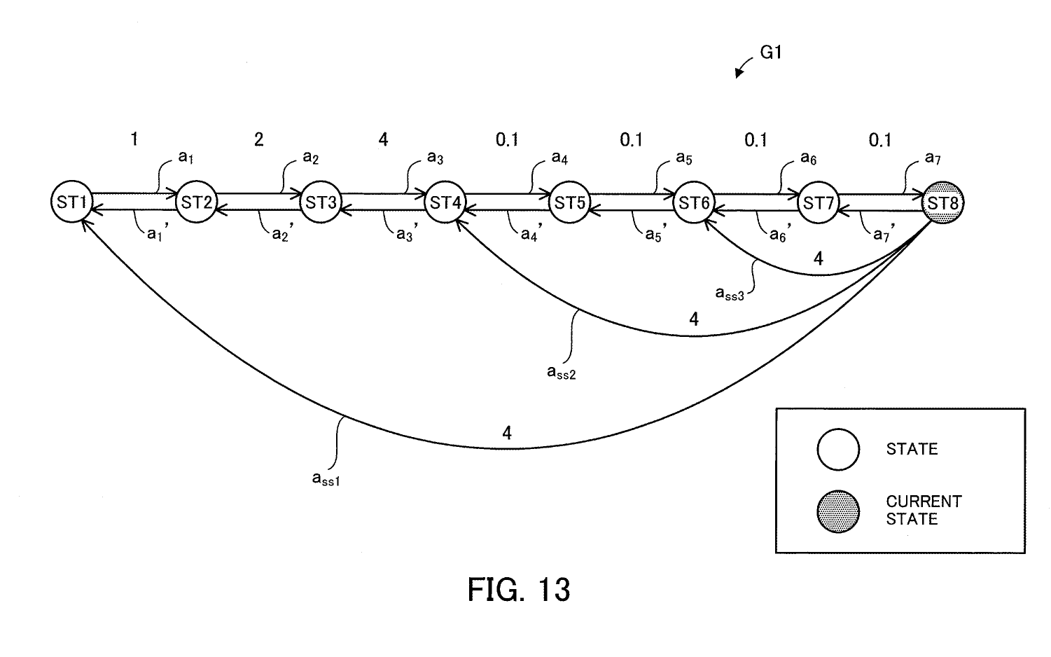

FIG. 13 illustrates an example of the state transition graph according to the second embodiment. The shortest operations list creating unit 150 generates a state transition graph G1 based on the operation execution record table 212, the snapshot record table 221, and the operation information table 231. The state transition graph G1 is a digraph with nodes corresponding to the states ST1, ST2, ST3, ST4, ST5, ST6, ST7, and ST8 of the virtual machine 21b and edges each corresponding to a transition between two of the states. The numerical number given above each edge in the state transition graph G1 indicates the amount of time needed for a restoration operation corresponding to the edge.

With reference to the operation execution record table 212, the shortest operations list creating unit 150 creates edges based on the previous state identifier, the subsequent state identifier, and the needed time of each record associated with the virtual machine 21b. A restoration operation causing a transition from a state ST(i) (i is an integer greater than or equal to 1) to a state ST(i+1) is denoted as “restoration operation aᵢ”. For example, a restoration operation causing a transition from the state ST1 to the state ST2 is a restoration operation a₁ (which corresponds to the operation OP1).

At this point, if a fallback operation identifier corresponding to the restoration operation aᵢ has been registered in the operation information table 231, the shortest operations list creating unit 150 creates an edge in the opposite direction, corresponding to the fallback operation. When the fallback operation corresponding to the restoration operation aᵢ exists, it is denoted as “restoration operation aᵢ′”. For example, a restoration operation causing a transition from the state ST2 to the state ST1 (i.e., a fallback operation corresponding to the restoration operation a₁) is a restoration operation a₁′ (which corresponds to the operation OP2).

Note that each edge represented by an arrow pointing from a previous state identifier to a subsequent state identifier indicates a forward state transition. Each edge represented by an arrow pointing from a subsequent state identifier to a previous state identifier indicates a backward state transition. Note also that, for ease of explanation, the state transition graph G1 illustrates a case in which paired forward and backward state transitions take the same amount of time. This is merely an example, and paired forward and backward state transitions may take a different amount of time. In addition, in the case of the state transition graph G1, a backward edge exists for each of the forward edges; however, no backward edges may exist for some of the forward edges.

On the other hand, restoration using a snapshot means restoring the virtual machine 21b from the current state Sc to a state Sss for which the snapshot was taken. Therefore, the shortest operations list creating unit 150 creates an edge causing a transition from the state Sc to the state Sss. In the example of the snapshot record table 221, the snapshot SS1 corresponds to the state ST1. Therefore, the shortest operations list creating unit 150 creates an edge causing a transition from the state ST8 to the state ST1. A restoration operation using the snapshot SS1 is denoted as “aₛₛ₁”. A snapshot SS2 corresponds to the state ST4 and, therefore, the shortest operations list creating unit 150 creates an edge causing a transition from the state ST8 to the state ST4. A restoration operation using the snapshot SS2 is denoted as “aₛₛ₂”. A snapshot SS3 corresponds to the state ST6 and, therefore, the shortest operations list creating unit 150 creates an edge causing a transition from the state ST8 to the state ST6. A restoration operation using the snapshot SS3 is denoted as “aₛₛ₃”.

Based on the state transition graph G1, the shortest list creating unit 150 produces the shortest operations list p(Sc, St) regarding a transition from the current state Sc to the designated state St. For example, assuming that the current state Sc is the state ST8 and the designated state St is the state ST2, a path routed through the states ST8, ST1, and ST2 in the stated order is the shortest path (the time needed: 5 minutes). There are other paths, such as a path sequentially heading back through the states ST8, ST7, . . . , and ST2 (6.4 minutes) and a path routed through the states ST8, ST4, ST3, and ST2 (10 minutes); however, the shortest path is the above-mentioned one with 5 minutes. A group of restoration operations corresponding to the shortest path is the shortest operations list p.

Specifically, the restoration operation from the state ST8 to the state ST1 is aₛₛ₁, and the restoration operation from the state ST1 to the state ST2 is a₁. Therefore, the shortest operations list p is [aₛₛ₁, a₁]. It is sometimes the case that, to shift from one state to another, both a restoration operation using a snapshot and a restoration operation not using a snapshot are available, and these restoration operations take the same amount of time. In this case, the shortest operations list creating unit 150 selects preferably the restoration operation not using a snapshot to create the shortest operations list p. This is because turning as many needless snapshots as possible into deletion targets contributes to saving storage space.

Note that the order of restoration operations in the square brackets of the shortest operations list p also indicates the execution sequence of the restoration operations. Restoration operations closer to the left side within the brackets are executed earlier, and those closer to the right side are executed later. That is, the operation executing unit 130 first causes the VMM 21a to perform restoration using the snapshot SS1 (the restoration operation aₛₛ₁). Then, the operation executing unit 130 causes the virtual machine 21b to perform restoration using the operation OP1 (the restoration operation a₁). Herewith, the virtual machine 21b is restored from the state ST8 to the state ST2.

Next described is how to determine a deletion-target snapshot. The process described below may be executed, for example, at one of the following times (1) to (5): (1) periodically (for example, daily, weekly, or monthly); (2) after a snapshot is taken (immediately after step S13 of FIG. 11); (3) after an operation is executed (immediately after step S19 of FIG. 11); (4) after a state restoration is performed (immediately after step S25 of FIG. 12); and (5) at a time designated by the user (upon receiving an instruction from the user, the user interface unit 110 causes the individual units of the state restoration apparatus 100 to determine a deletion target). In the case of (2) to (4), a deletion target is determined from among snapshots taken for a device undergoing release work or state restoration. In the case of (1) and (5), a deletion target is determined from among snapshots taken for a device designated as scheduled or by the user.

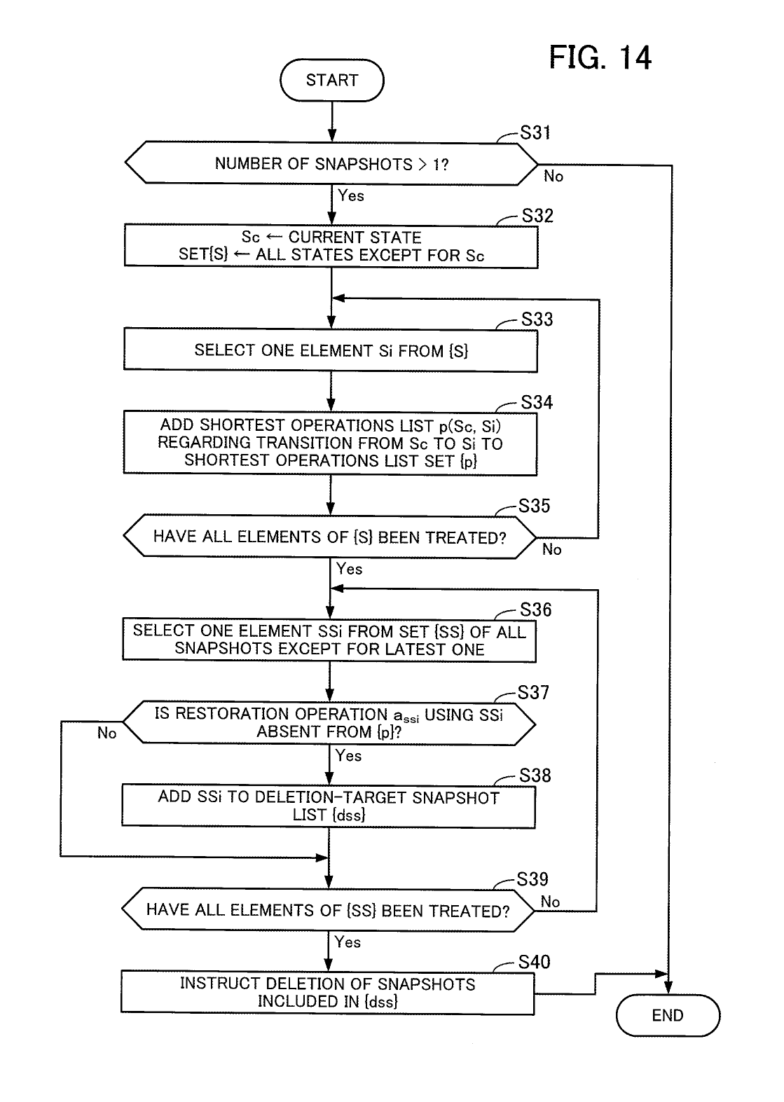

FIG. 14 is a flowchart illustrating an example of determining a deletion target according to the second embodiment. The process of FIG. 14 is described next according to the step numbers in the flowchart. Note that the following describes a case in which the process is carried out for snapshots taken for the virtual machine 21b. Note however that a similar procedure is also applicable to determining a deletion target from among snapshots taken for a different device.

[Step S31] With reference to the snapshot database 220, the shortest operations list creating unit 150 determines whether the number of snapshots of the virtual machine 21b stored therein is larger than 1. If the number of the snapshots is larger than 1, the process moves to step S32. If the number of the snapshots is less than or equal to 1, the process ends.

[Step S32] The shortest operations list creating unit 150 assigns the current state of the virtual machine 21b to the variable Sc. A collection of state identifiers of all the states of the virtual machine 21b, except for the current state Sc, is here referred to as a state set {S}. The states of the virtual machine 21b are understood from the state record table 211. According to the example of the state record table 211, the state set {S}={ST1, ST2, ST3, ST4, ST5, ST6, ST7} when the current state is the state ST8.

[Step S33] The shortest operations list creating unit 150 selects one element Si from the set {S}. Each element having already undergone step S34 below is excluded from the available choices.

[Step S34] The shortest operations list creating unit 150 adds the shortest operations list p(Sc, Si) regarding a transition from the state Sc to the state Si to a set {p} of shortest operations lists (hereinafter simply referred to as the “shortest operations list set {p}”). The method for calculating the shortest operations list p(Sc, Si) is as illustrated in FIGS. 12 and 13.

[Step S35] The shortest operations list creating unit 150 determines whether all the elements of the set {S} have been treated (i.e., whether the shortest operations list p has been obtained for each of all the elements). If all the elements have been treated, the process moves to step S36. If one or more elements remain untreated, the process moves to step S33.

[Step S36] The snapshot deletion determining unit 160 sets a set of all snapshots of the virtual machine 21b, except for the latest one, as a set {SS}. Assuming that, amongst snapshots SS1, SS2, and SS3, the latest snapshot is the snapshot SS3, the set {SS}={SS1, SS2}. The snapshot deletion determining unit 160 selects an element SSi from the set {SS}. Each element having already undergone step S37 below (or step S38 depending on the determination result in step S37) is excluded from the available choices.

[Step S37] The snapshot deletion determining unit 160 determines whether a restoration operation aₛₛᵢ using the snapshot SSi is included in the shortest operations list set {p}. If it is not included, the process moves to step S38. If it is included, the process moves to step S39.

[Step S38] The snapshot deletion determining unit 160 adds the snapshot SSi to a deletion-target snapshot list {dss}.

[Step S39] The snapshot deletion determining unit 160 determines whether all the elements of the set {SS} have been treated. If all the elements have been treated, the process moves to step S40. If one or more elements remain untreated, the process moves to step S36.

[Step S40] The snapshot deletion determining unit 160 deletes records of snapshots included in the deletion-target snapshot list {dss} from the snapshot record table 221. The snapshot deletion determining unit 160 instructs the VMM 21a to delete data of the snapshots included in the deletion-target snapshot list {dss}.

Note that the determination in step S31 is made to keep the latest snapshot. Before the next snapshot is taken, an operation whose fallback operation is not registered in the operation information table 231 may be executed. In even such a case, keeping the latest snapshot undeleted allows state restoration using the snapshot. For the same reason, the latest snapshot is also excluded from the processing targets in steps S36 to S38.

Note however that step S31 may be changed to determine “whether one or more snapshots of the virtual machine 21b are present”. In this case, deletion targets are determined, in steps S36 to S38, from among all snapshots of the virtual machine 21b including the latest one.

In step S32, the state identifier of the current state is assigned to the variable Sc; however, the state identifier of a previous state may be assigned to the variable Sc. For example, the shortest operations list creating unit 150 may allow the user to choose any point in time and input the state identifier of a state at the point. In that case, the set {S} is a collection of states obtained prior to the state assigned to the variable Sc. In addition, the set {SS} in step S36 is a collection of snapshots taken prior to the state assigned to the variable Sc. In this regard, amongst the snapshots taken prior to the state, the latest one is not included in the set {SS}. In this manner, it is possible to sort snapshots taken in the lead up to the time point designated by the user. This is useful, for example, to sort snapshots taken up to a specific point in time in the past.

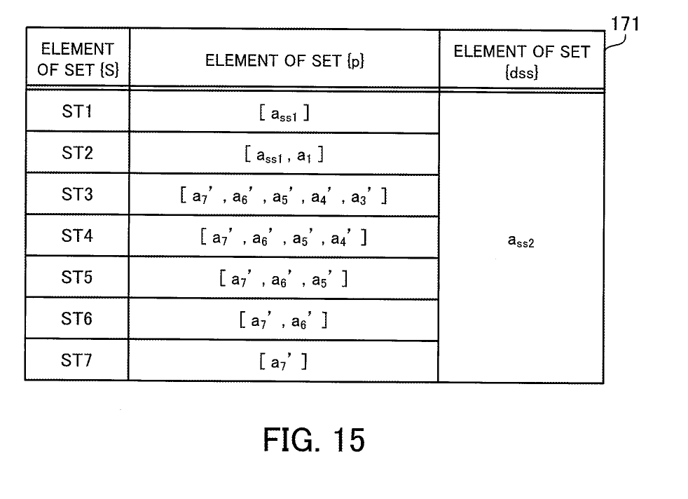

FIG. 15 illustrates an example of deletion target determination according to the second embodiment. A table 171 illustrates the sets {S}, {p}, and {dss} obtained based on the operation execution record table 212, the snapshot record table 221, and the operation information table 231. The snapshot deletion determining unit 160 determines elements of the set {dss} based on the information of the set {p} created by the shortest operations list creating unit 150.

Specifically, the shortest operations list creating unit 150 creates the following shortest operations lists as elements of the set {p} for all the states. As for the state ST1, p=[aₛₛ₁]. As for the state ST2, p=[aₛₛ₁, a₁]. As for the state ST3, p=[a₇′, a₆′, a₅′, a₄′, a₃′]. As for the state ST4, p=[a₇′, a₆′, a₅′, a₄′]. As for the state ST5, p=[a₇′, a₆′, a₅′]. As for the state ST6, p=[a₇′, a₆′]. As for the state ST7, p=[a₇′]. Of the elements of the set {SS}={SS1, SS2}, the snapshot SS2 is not used by any element of the set {p} (the snapshot SS1 is used in the restoration operation aₛₛ₁). Therefore, the snapshot deletion determining unit 160 determines that the deletion-target snapshot list {dss}={aₛₛ₂}.

Based on the deletion-target snapshot list {dss}, the snapshot deletion determining unit 160 deletes the record of the snapshot SS2 from the snapshot record table 221. The snapshot deletion determining unit 160 also instructs the VMM 21a to delete data of the snapshot SS2. According to the instruction, the VMM 21a deletes the snapshot SS2 from the snapshot database 220.

Note that, as illustrated in FIG. 13, when the virtual machine 21b is restored to a state in the past (for example, the state ST2), a transition may be made from the state to a new state different from an existing state (for example, the state ST3). The state restoration apparatus 100 may record such transitions from one state to a plurality of states.

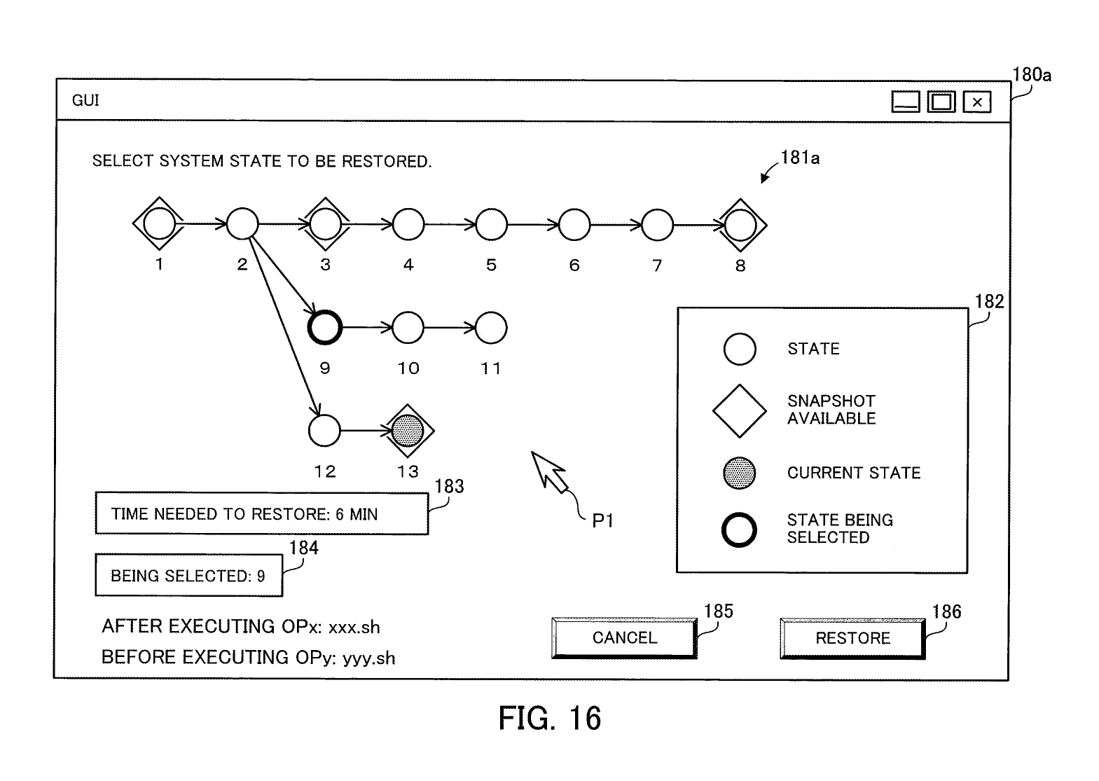

FIG. 16 illustrates another example of the GUI according to the second embodiment. A GUI 180a, in place of the GUI 180, is generated by the user interface unit 110, and then provided for the terminal 300. The GUI 180a differs from the GUI 180 in displaying a state transition diagram 181a. In the state transition diagram 181a, the transition path from the state ST2 branches into three states ST3, ST9, and ST12. Thus, also in the case where transitions are made from one state to a plurality of states, the designation of a restoration-target state is possible, as in the case above.

In this case also, the shortest operations list creating unit 150 calculates the shortest operations list in a manner similar to that described in FIGS. 12 and 13. Further, the operation executing unit 130 causes the server 21, or the like, to sequentially execute restoration operations included in the shortest operations list, to thereby perform state restoration in the shortest amount of time needed.

In addition, the shortest operations list creating unit 150 calculates the shortest operations list set {p} regarding transitions from the current state to other states in a manner similar to that described in FIGS. 14 and 15. Further, the snapshot deletion determining unit 160 determines, as deletion targets, snapshots not included in the set {p} as its elements.

As has been described above, according to the state restoration apparatus 100, it is possible to save space to store snapshots (the storage space of the storage unit 200 in the example of the second embodiment) while speeding up restoration. In addition, the state restoration apparatus 100 is able to support the state restoration function in such a manner as to promote efficient use of the storage space.

Note here that, in release work, it is sometimes the case that the user causes the server 21, the virtual machine 21b, or the like to execute incorrect operations. In this case, the execution of the incorrect operations is likely to entail restoration work and another round of release work, taking too long on the release work. This problem also remains for the case where operations of release work are created in advance. For example, a creator may create operations through a trial and error process in a test environment. If unintended results are produced by trial operations in the trial and error process, a do-over starting from the establishment of the test environment may be inevitable. For this reason, there is a need for expeditiously restoring a state of the system. Especially, changes in markets are fast-paced in recent years, and in keeping with this trend, it is sought to speed up the cycles of development and implementation more than ever.

In this regard, preparing fallback operations corresponding to operations involved in release work may allow the system to be restored to a state before setting changes, as described above. However, the amount of time needed for individual operations (and individual fallback operations) vary significantly. For example, a simple editing task of a configuration file may be completed in a few seconds to a few minutes (for example, 30 seconds). On the other hand, installation of massive middleware and an operating system update may take a few minutes to a few hours (for example, 60 minutes).

In addition, it is sometimes the case that simple fallback operations are not available. This happens, for example, in the case of redoing work from formatting of a storage device, such as a HDD or SSD, or operating system installation. Further, there are circumstances when no fallback operations exist. Therefore, state restoration by sequentially executing fallback operations, or the like, may take an immense amount of time.

In view of the problems above, it is considered to use snapshots because there is an advantage that acquisition of a snapshot and restoration using a snapshot are performed in a more or less predetermined amount of time compared to restoration using operations. Use of snapshots may allow higher-speed restoration to a restoration-target state than sequentially executing fallback operations or the like. For example, to perform restoration from one state to another, using a snapshot realizing the state transition sometimes takes less time than the total execution time needed to sequentially execute a plurality of operation data pieces for the state transition.

However, data of snapshots needs to be stored in order to use the snapshots, which may put pressure on the space of the storage device. This is because the amount of snapshot data is proportional to the amount of memory allocated to a virtual machine, or the like, for which snapshots are taken. Taking snapshots at the same frequency as the execution of operations results in a vast amount of storage. On the other hand, decreasing the frequency of a snapshot being taken makes it difficult to restore the device to a state obtained at one point in time, for example, a state obtained at a point in time between two snapshots.

On the other hand, the state restoration apparatus 100 performs state restoration by combining the use of snapshots and operation data pieces written, for example, in shell scripts, to thereby speed up restoration to a state at a point in time. Note however that, in this case also, the space of the storage device may still be placed under pressure depending on the frequency of a snapshot being taken. In view of this, when a restoration operation using a snapshot is not used in any of the shortest operations lists regarding transitions from the current state to other states, the state restoration apparatus 100 deletes the snapshot from the snapshot database 220. This is because keeping snapshots not contributing to speeding up restoration is ineffectual. Herewith, it is possible to save storage space while securing the shortest restoration operations.

For example, the size of a snapshot may range from a few megabytes to as much as several tens of gigabytes while the size of an operation data piece is a few kilobytes. Therefore, deletion of needless snapshots contributes much to saving storage space. In addition, in the case of incorrect manipulation during the development or execution of operations, the state restoration apparatus 100 is able to restore the system to its original state at a high speed, which enables labor saving for users and a reduction in their workload.

### (c) Third Embodiment

A third embodiment is described next. While omitting repeated explanations, the following description focuses on differences from the second embodiment above.

Two types of snapshot methods may be available to take a snapshot: full and differential. The full snapshot method takes, as a snapshot, full information indicating the state of the virtual machine 21b, or the like, at a particular point in time. The differential snapshot method takes, as a snapshot, only information representing difference from a snapshot taken last time amongst full information indicating the state of the virtual machine 21b, or the like, at a particular point in time. The term “snapshot taken last time” is either one of a full snapshot and a differential snapshot. Note that, of the two snapshot types, the “snapshots” in the second embodiment are full snapshots.

In the case of restoring a state of a device using a differential snapshot, the device needs to be in a state corresponding to a different snapshot taken last time. That is, a differential snapshot is dependent on a different snapshot in state restoration. The third embodiment is directed to providing a snapshot management function in consideration of a case where snapshots have dependency relationships.

An information processing system according to the third embodiment is the same as the information processing system of the second embodiment illustrated in FIG. 2. In addition, examples of hardware and functions of a state restoration apparatus according to the third embodiment are the same as those of the state restoration apparatus 100 illustrated in FIGS. 3 and 4. For this reason, individual devices of the third embodiment are identified by the same names and reference numerals as those used in the second embodiment. In the third embodiment, the state restoration apparatus 100 manages the above-described dependency relationships among snapshots.

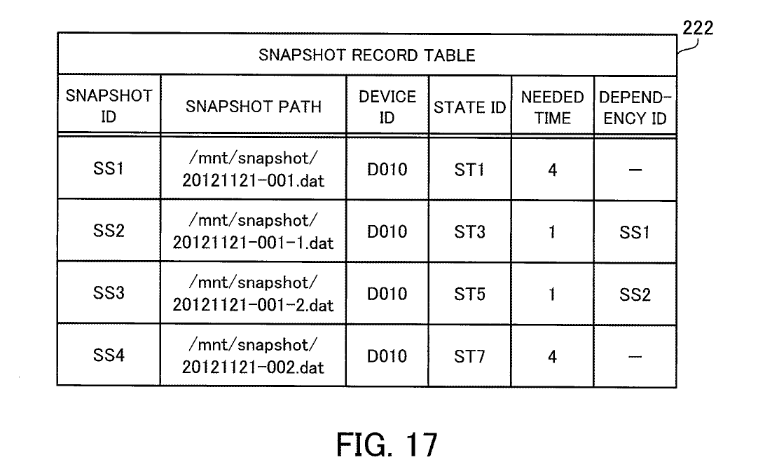

FIG. 17 illustrates an example of a snapshot record table according to the third embodiment. A snapshot record table 222 is stored in the snapshot database 220, in place of the snapshot record table 221. The snapshot record table 222 includes columns of the following items: snapshot identifier; snapshot path; device identifier; state identifier; needed time; and dependency identifier. Contents set in the snapshot identifier column, the snapshot path column, the device identifier column, the state identifier column, and the needed time column are the same as those in the snapshot record table 221. The snapshot record table 222 differs from the snapshot record table 221 in including the dependency identifier column. Each field in the dependency identifier column contains the snapshot identifier of a snapshot on which the corresponding snapshot is dependent.

For example, a record with “SS1” in the snapshot identifier column; “/mnt/snapshot/20121121-001.dat” in the snapshot path column; “D010” in the device identifier column; “ST1” in the state identifier column; “4 (min)” in the needed time column; and “-” (hyphen) in the dependency identifier column is registered in the snapshot record table 222. The setting examples, except for the dependency identifier column, are the same as those in the snapshot record table 221. “-” in the dependency identifier column indicates that a NULL value is registered as the dependency identifier, which means that the snapshot SS1 is not dependent on another snapshot. That is, the snapshot SS1 is a full snapshot.

In addition, a record with “SS2” in the snapshot identifier column; “/mnt/snapshot/20121121-001-1.dat” in the snapshot path column; “D010” in the device identifier column; “ST3” in the state identifier column; “1 (min)” in the needed time column; and “SS1” in the dependency identifier column is registered in the snapshot record table 222. This record indicates that the snapshot SS2 with the snapshot identifier “SS2” and the snapshot path “/mnt/snapshot/20121121-001-1.dat” has been taken for a device identified by the device identifier “D010”. The record also indicates that the snapshot corresponds to the state ST3 of the device, and that state restoration using the snapshot SS2 takes 1 minute. Further, the record indicates that the snapshot SS2 is dependent on the snapshot SS1. That is, the snapshot SS2 is a differential snapshot.

In the following description, in order to distinguish the snapshot acquisition method of each snapshot, a notation such as “full snapshot SS1” or “differential snapshot SS2” is employed. When the simple term “snapshot” is used, it may refer to both a full and a differential snapshot.

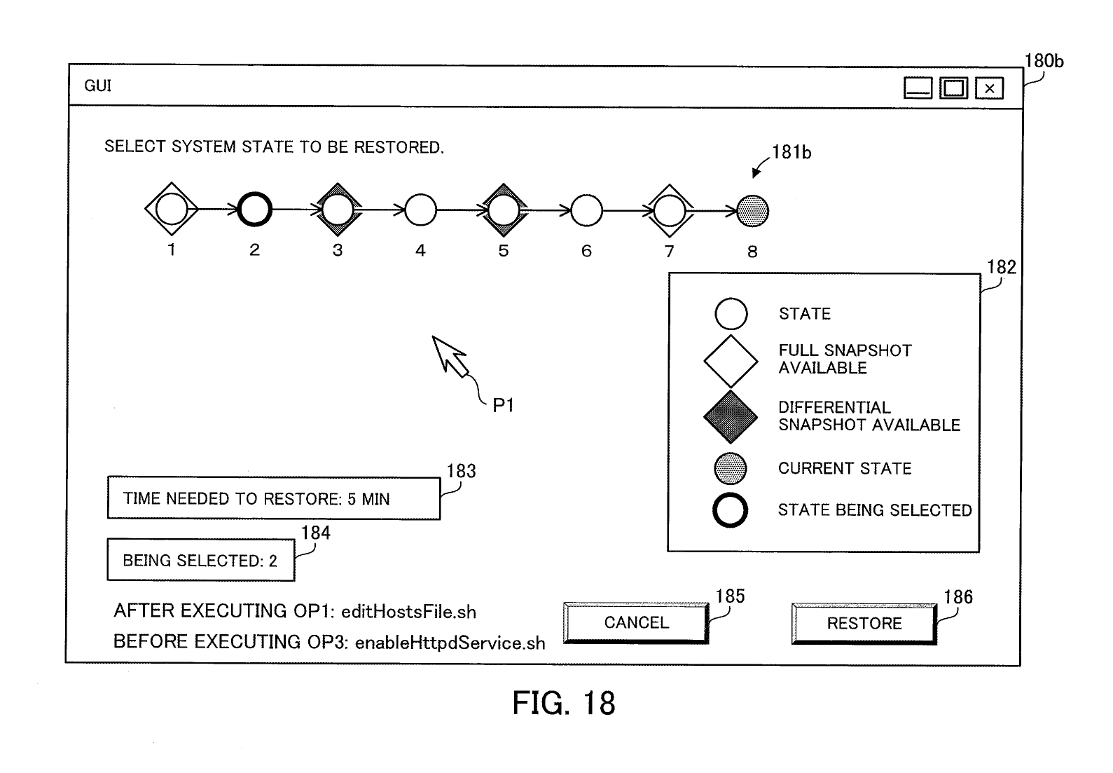

FIG. 18 illustrates an example of a GUI according to the third embodiment. A GUI 180b, in place of the GUI 180 or 180a, is generated by the user interface unit 110, and then provided for the terminal 300. The GUI 180b differs from the GUIs 180 and 180a in displaying a state transition diagram 181b. The state transition diagram 181b is an image of state transitions of the device identified by the device identifier “D010”, illustrated based on the operation information table 231, the operation execution record table 212, and the snapshot record table 222.

The display of the state transition diagram 181b distinguishes between states for which a full snapshot has been taken and those for which a differential snapshot has been taken. Specifically, each circle in an outlined square represents a state for which a full snapshot has been taken. Each circle in a shaded square represents a state for which a differential snapshot has been taken. The remaining symbols are the same as those in the state transition diagram 181. The legend 182 explains what each symbol used in the state transition diagram 181b means, distinguishing between full snapshots and differential snapshots. Providing the GUI 180b for the terminal 300 allows the user to understand whether each state with a snapshot is a state with a full snapshot or a state with a different snapshot. The user is then able to select a restoration-target state.

Next described are processes according to the third embodiment. Note that an operation execution process involved in release work according to the third embodiment is the same as the operation execution example of the second embodiment illustrated in FIG. 11. In addition, a state restoration process according to the third embodiment is the same as the state restoration example of the second embodiment illustrated in FIG. 12.

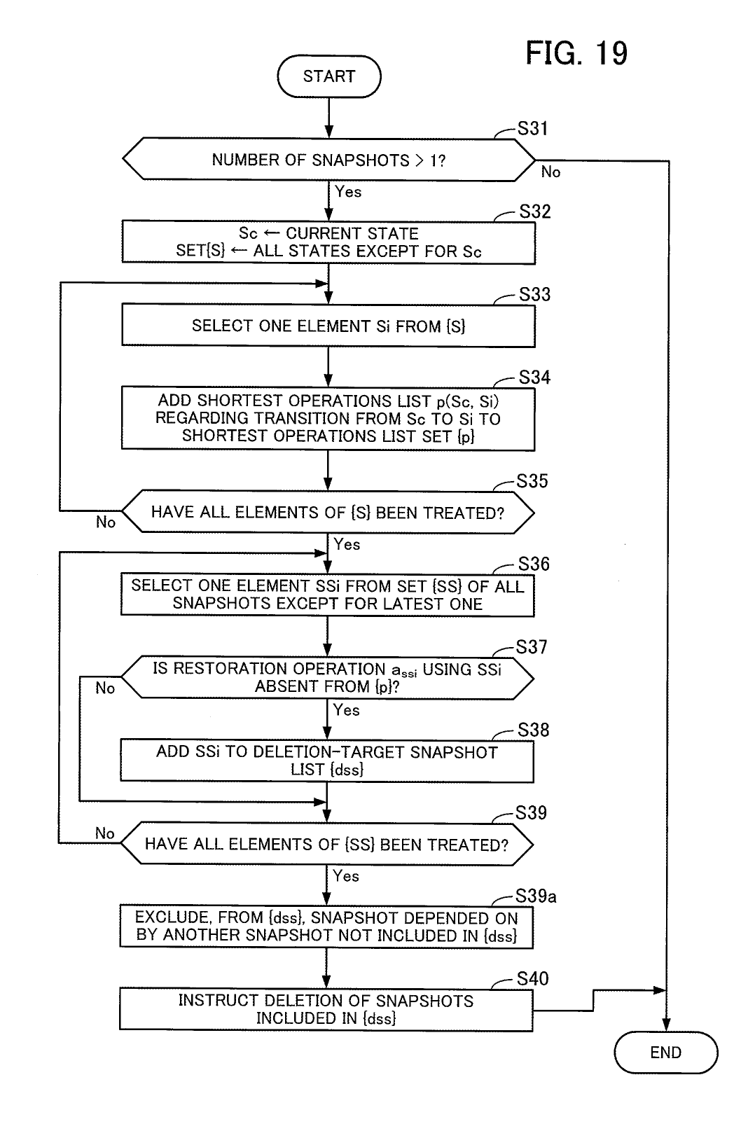

FIG. 19 is a flowchart illustrating an example of determining a deletion target according to the third embodiment. The process of FIG. 19 is described next according to the step numbers in the flowchart. This example is different from the example described in the second embodiment in executing step S39a between steps S39 and S40. Therefore, the following explains only step S39a while omitting repeated explanations of the remaining steps.

[Step S39a] Based on the snapshot record table 222, the snapshot deletion determining unit 160 determines, amongst snapshots included in the deletion-target snapshot list {dss}, each snapshot directly or indirectly depended on by another snapshot not included in the deletion-target snapshot list {dss}. The snapshot deletion determining unit 160 excludes the determined snapshot from the deletion-target snapshot list {dss}.

In this manner, the snapshot deletion determining unit 160 checks on a dependency relationship of a first snapshot included in the deletion-target snapshot list {dss}. (1) The snapshot deletion determining unit 160 holds the first snapshot as a deletion target if it is not depended on by a second snapshot. (2) In the case where, although the first snapshot is depended on by the second snapshot, the second snapshot and a third snapshot dependent on the second snapshot are all recursively included in the deletion-target snapshot list {dss}, the snapshot deletion determining unit 160 holds a group of these snapshots as a deletion target. The snapshot deletion determining unit 160 deletes snapshots not falling under (1) or (2) above from the deletion-target snapshot list {dss}. Step S39a may be said to be a step to exclude, from deletion targets, a snapshot if a restoration operation using the snapshot is included in a shortest operations list (or if the snapshot is a precondition of a restoration operation using another snapshot, which restoration operation is included in a shortest operations list).

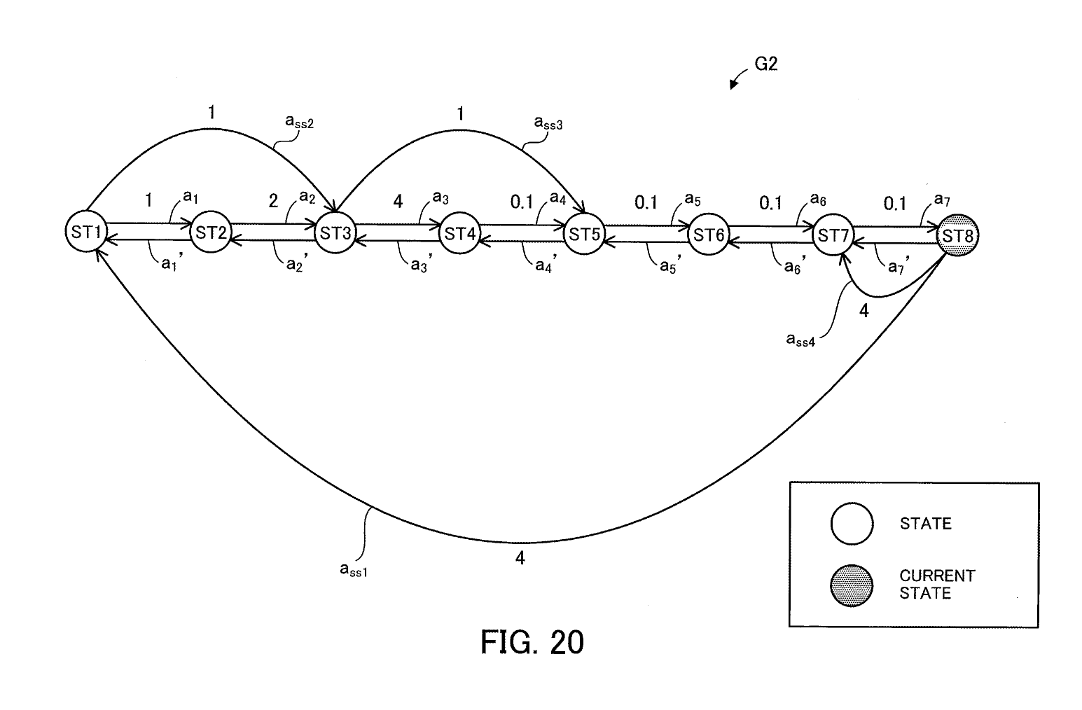

FIG. 20 illustrates a first example of a state transition graph according to the third embodiment. The shortest operations list creating unit 150 generates a state transition graph G2 based on the operation execution record table 212, the snapshot record table 222, and the operation information table 231. The third embodiment differs from the second embodiment in differential snapshots SS2 and SS3 and a full snapshot SS4 having been taken.

The differential snapshot SS2 is used for restoration from the state ST1 to the state ST3. The differential snapshot SS3 is used for restoration from the state ST3 to the state ST5. The restoration using each of the differential snapshots SS2 and SS3 takes 1 minute. The full snapshot SS4 is used for restoration to the state ST7. The restoration using the full snapshot SS4 takes 4 minutes. In the state transition graph G2, a restoration operation using the differential snapshot SS2 is denoted as “aₛₛ₂”; a restoration operation using the differential snapshot SS3 is denoted as “aₛₛ₃”; and a restoration operation using the differential snapshot SS4 is denoted as “aₛₛ₄”.

As illustrated in the snapshot record table 222, the differential snapshot SS2 is dependent on the full snapshot SS1. The differential snapshot SS3 is dependent on the differential snapshot SS2. In this case, it may be said that the full snapshot SS1 is directly depended on by the differential snapshot SS2 and indirectly depended on by the differential snapshot SS3 (via the differential snapshot SS2). In addition, the differential snapshot SS2 is directly depended on by the differential snapshot SS3.

That is, in the case of performing restoration from the current state Sc to the state ST3 using the differential snapshot SS2, the VMM 21a sequentially executes the restoration operations aₛₛ₁ and aₛₛ₂. In the case of performing restoration from the current state Sc to the state ST5 using the differential snapshot SS3, the VMM 21a sequentially executes the restoration operations aₛₛ₁, aₛₛ₁, and aₛₛ₃. Thus, restoration using a differential snapshot is performed in combination with other snapshots each having a dependency relationship with the differential snapshot. Because restoration using a differential snapshot is controlled by the VMM 21a, it is difficult to perform the restoration in combination with operation data pieces written, for example, in shell scripts.

Based on the state transition graph G2, the shortest operations list creating unit 150 obtains the set {p} of the shortest operations lists p(Sc, Si) regarding a transition from the current state Sc to each of the remaining states Si. The way to obtain the set {p} is the same as that described in the second embodiment.

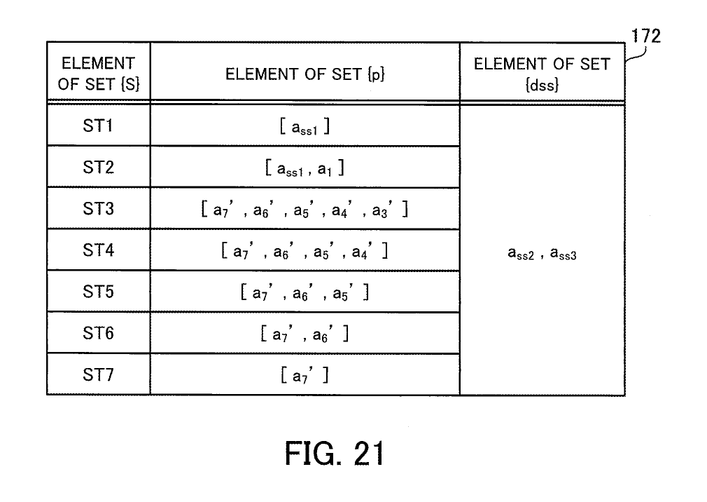

FIG. 21 illustrates a first example of deletion target determination according to the third embodiment. A table 172 illustrates the sets {S}, {p}, and {dss} obtained based on the operation execution record table 212, the snapshot record table 222, and the operation information table 231. The snapshot deletion determining unit 160 determines elements of the set {dss} based on the information of the set {p} created by the shortest operations list creating unit 150.

Specifically, the shortest operations list creating unit 150 creates the following shortest operations lists as elements of the set {p} for all the states. As for the state ST1, p=[aₛₛ₁]. As for the state ST2, p=[aₛₛ₁, a₁]. As for the state ST3, p=[a₇′, a₆′, a₅′, a₄′, a₃′]. As for the state ST4, p=[a₇′, a₆′, a₅′, a₄′]. As for the state ST5, p=[a₇′, a₆′, a₅′]. As for the state ST6, p=[a₇′, a₆′]. As for the state ST7, p=[a₇′]. Of the elements of the set {SS}={SS1, SS2, SS3}, the differential snapshots SS2 and SS3 are not used by any element of the set {p} (the full snapshot SS1 is used by the restoration operation aₛₛ₁). Therefore, the snapshot deletion determining unit 160 determines that the deletion-target snapshot list {dss}={aₛₛ₂, aₛₛ₃}.

Further, the differential snapshot SS2 is directly depended on by the differential snapshot SS3, as described above; however, the differential snapshot SS3 is also included in the deletion-target snapshot list {dss}. The differential snapshot SS2 is not depended on by a snapshot other than the differential snapshot SS3. Therefore, the snapshot deletion determining unit 160 keeps the differential snapshot SS2 as a deletion target. The differential snapshot SS3 is not depended on by any snapshot. Therefore, the snapshot deletion determining unit 160 keeps the differential snapshot SS3 as a deletion target.

Based on the deletion-target snapshot list {dss}, the snapshot deletion determining unit 160 deletes the records of the differential snapshots SS2 and SS3 from the snapshot record table 222. In addition, the snapshot deletion determining unit 160 instructs the VMM 21a to delete data of the differential snapshots SS2 and SS3. According to the instruction, the VMM 21a deletes the differential snapshots SS2 and SS3 from the snapshot database 220.

Thus, the state restoration apparatus 100 determines deletion-target snapshots in consideration of dependency relationships among snapshots. This is because determining deletion targets in disregard of the dependency relationships may preclude restoration using a differential snapshot included in a shortest operations list. For example, if one of the full snapshot SS1 and the differential snapshot SS2 is deleted, the VMM 21a is not able to perform restoration using the differential snapshot SS3. Therefore, by determining deletion-target snapshots in consideration of dependency relationships among snapshots, as described above, it is possible to prevent restoration using a differential snapshot from being precluded.

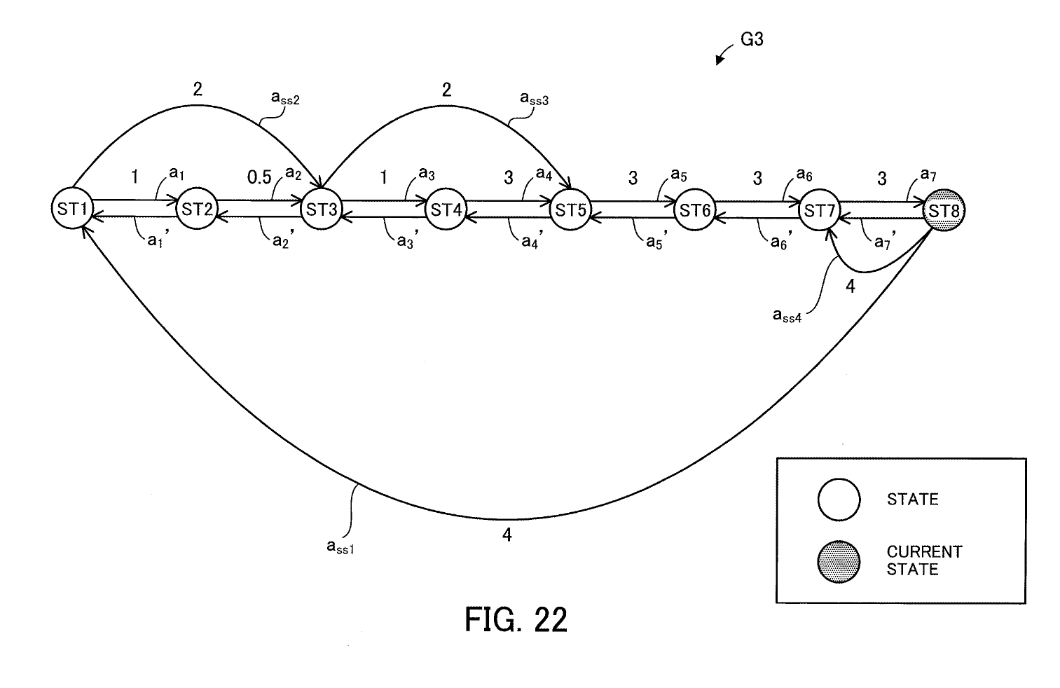

FIG. 22 illustrates a second example of the state transition graph according to the third embodiment. Although having the same connection relationship of nodes and edges as the state transition graph G2, a state transition graph G3 has lengths of edges (the length of each edge corresponds to the amount of time needed for its associated restoration operation) different from those of the state transition graph G2. The amount of time needed for each restoration operation is as follows: each of the restoration operations a₁, a_{1′}, a₃, and a_{3′} takes 1 minute; each of the restoration operations a₂, and a₂, takes 0.5 minutes; each of the restoration operations a₄, a_{4′}, a₅, a_{5′}, a₆, a_{6′}, a₇, and a_{7′} takes 3 minutes; each of the restoration operations aₛₛ₁, and aₛₛ₄ takes 4 minutes; and each of the restoration operations aₛₛ₁, and aₛₛ₃ takes 2 minutes. Assuming that the current state is ST8, the state restoration apparatus 100 determines a deletion-target snapshot, according to the process illustrated in FIG. 19, based on the state transition graph G3 as follows.

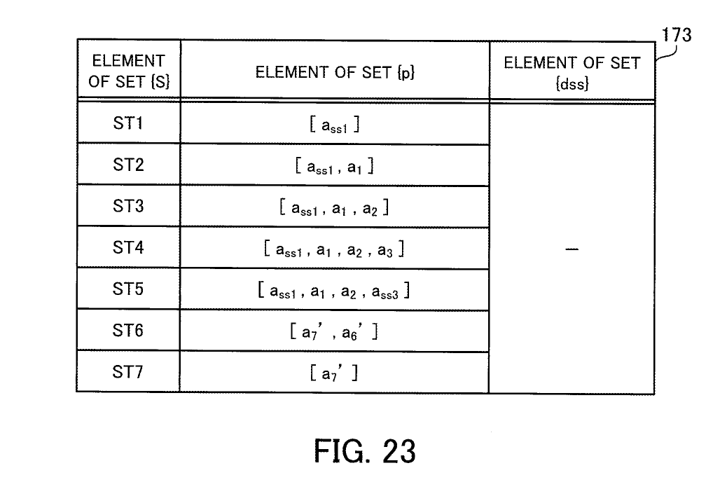

FIG. 23 illustrates a second example of deletion target determination according to the third embodiment. A table 173 illustrates the sets {S}, {p}, and {dss} obtained for the state transition graph G3. Specifically, the shortest operations list creating unit 150 creates the following shortest operations lists as elements of the set {p} for all the states. As for the state ST1, p=[aₛₛ₁]. As for the state ST2, p=[aₛₛ₁, a₁]. As for the state ST3, P=[aₛₛ₁, a₁, a₂]. As for the state ST4, p=[aₛₛ₁, a₁, a₂, a₃]. As for the state ST5, p=[aₛₛ₁, a₁, a₂, aₛₛ₃]. As for the state ST6, p=[a₇′, a₆′]. As for the state ST7, p=[a₇′].

Of the elements of the set {SS}={SS1, SS2, SS3}, the differential snapshot SS2 is not used by any element of the set {p}. Specifically, the full snapshot SS1 is used by the restoration operation aₛₛ₁, and the differential snapshot SS3 is used by the restoration operation aₛₛ₃. Therefore, the snapshot deletion determining unit 160 determines that the deletion-target snapshot list {dss}={aₛₛ₂}.

Note however that the differential snapshot SS2 is directly depended on by the differential snapshot SS3, as described above. In addition, in the example illustrated in FIGS. 22 and 23, the differential snapshot SS3 is not included in the deletion-target snapshot list {dss}. Therefore, the snapshot deletion determining unit 160 excludes the differential snapshot SS2 from the deletion-target snapshot list {dss}. That is, the differential snapshot SS2 is excluded from being a deletion target.

As a result, the deletion-target snapshot list {dss} has no elements. In the example of FIGS. 22 and 23, there is no snapshot to be deleted. Note here that the differential snapshot SS3 is used for restoration to the state ST5, but dependent on the differential snapshot SS2. Therefore, deleting the differential snapshot SS2 precludes the VMM 21a from performing restoration using the differential snapshot SS3. In view of this, the state restoration apparatus 100 excludes the differential snapshot SS2 listed up in the deletion-target snapshot list {dss} from being a deletion target.

Herewith, as for restoration performed by the VMM 21a using the differential snapshot SS3, it is possible to secure a method of sequentially applying the snapshots SS1, SS2, and SS3. Specifically, when the execution of the restoration operation aₛₛ₁ is a precondition for the restoration operation aₛₛ₃ to be executed in restoration processing by the VMM 21a, the VMM 21a is caused to execute an operations list [aₛₛ₁, aₛₛ₁, aₛₛ₃] for restoration to the state ST5, in place of an operations list [aₛₛ₁, a₁, a₂, aₛₛ₃] (the snapshot deletion determining unit 160 instructs execution of the alternative operations list). In this case also, it is possible to perform, by the VMM 21a, appropriate restoration using differential snapshots.

The latest snapshot is kept in the above examples. Note however that the latest snapshot may be a deletion target as described above, if restoration to a state at which the latest snapshot was taken is possible by using operation data pieces written, for example, in shell scripts, taking the same amount or less time than using the latest snapshot. In the example of FIG. 22, restoration to the state ST7 at which the latest snapshot was taken is also possible to be made from the current state ST8 by using the restoration operation a₇′. Further, the amount of time needed for the restoration operation a₇′ (3 minutes) is equal to or less than the amount of time needed for the restoration operation aₛₛ₄ (4 minutes). Therefore, in this case, it may be considered to determine the full snapshot SS4 as a deletion target.

In addition, as described above, the amount of time needed for each restoration operation using an operation data piece or a snapshot is obtained by actual measurements, or simply given. Note however that the amount of time needed for each restoration operation may vary depending on the operating environment of each device (for example, depending on the processing performance of a processor and a disk being a HDD or SSD). For this reason, recording the amount of time needed for each restoration operation, obtained by actual measurements enables calculation of shortest restoration operations with the needed amount of time more accurately reflecting the actual environment. To obtain actual measurements, the following methods are, for example, possible: making actual measurements in a test environment with a device having the same performance; estimating the amount of time needed by recording and then statistically processing the time obtained when each restoration operation is executed under various environments; and estimating the amount of time needed to execute each restoration operation based on an operating environment (for example, performance of the device).

Further, a restriction may be placed on restoration using a snapshot. For example, it is sometimes the case that, even if a state of the virtual machine 21b alone may be restored using a snapshot, the virtual machine 21b may not run properly without restoration of associated devices (for example, the storage unit 22 and the router 23) to their settings corresponding to the state of the virtual machine 21b. In such a case, restoration as the system is not achieved with only the restoration of the virtual machine 21b, and the restoration of the associated devices is also needed. In view of this, a snapshot taken in setting changes having effects also on settings of the associated devices may not be used in the above-described restoration of the virtual machine 21b (in this case, the virtual machine 21b is restored together with restoration of the settings of the associated devices using only operations written, for example, in shell scripts).

For example, in step S18 of FIG. 11, the execution result registering unit 140 detects that setting changes by the operation data piece have been made not only to the virtual machine 21b but also to the storage unit 22 and the router 23. In this case, if a snapshot was taken in step S13 just past, the execution result registering unit 140 registers, in the snapshot record table 221, information indicating that the snapshot is not to be used for restoration. At a later point, with reference to the snapshot record table 221, the shortest operations list creating unit 150 and the snapshot deletion determining unit 160 exclude, from processing targets, snapshots each with the information indicating that the snapshot is not to be used for restoration.

In addition, an operation data piece being large in size may be selected as a deletion target. In the above example, snapshots commonly have a large data size (a few megabytes to several tens of gigabytes) compared to operation data pieces (several tens of bytes to a few kilobytes). Note however that an operation data piece sometimes has a data size as large as that of a snapshot despite the operation data piece being used in only a single setting change. A transaction log of a database is an example of such an operation data piece. The state restoration apparatus 100 searches for operation data pieces of this kind. Then, when having found such an operation data piece, the state restoration apparatus 100 may preferentially delete the operation data piece over snapshots if the state to which transition is made using the operation data piece is restorable using snapshots and other operation data pieces. For example, a threshold (for example, 100 megabytes) is set for the data size of operation data pieces, and the state restoration apparatus 100 searches for operation data pieces exceeding the threshold. This further facilitates storage space saving.

The embodiments above particularly illustrate snapshots of the virtual machine 21b; however, the methods according to the second and third embodiments are also applicable to snapshots taken for a database and the server 21. As for a database, transaction logs may be used as operation data pieces. As for the server 21, shell scripts may be used as operation data pieces, as in the case of the virtual machine 21b.

Note that the information processing of the first embodiment is implemented by causing the calculating unit 1b to execute a program. Also, the information processing of the second embodiment is implemented by causing the processor 101 to execute the program. Such a program may be recorded in computer-readable storage media (for example, the optical disk 13, the memory device 14, and the memory card 16). For example, storage media on which the program is recorded are distributed in order to deliver the program to individual recipients. In addition, the program may be stored in a different computer and then distributed via a network. A computer stores, or installs, the program recorded in the storage medium or received from the different computer in a storage device, such as the RAM 102 or the HDD 103, and reads the program from the storage device to execute it.

According to one aspect, it is possible to save storage space while speeding up restoration.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a state restoration program that causes a computer to perform a procedure comprising:
calculating, based on information indicating a chronological order of a plurality of states of an apparatus, information indicating an amount of time needed to execute each of a plurality of commands, causing a forward or backward transition between two of the states, and information indicating an amount of time needed for restoration to, among the states, each state for which a snapshot has been taken, using the snapshot, shortest operation paths, each for restoring the apparatus from a restoration origin state to one of the remaining states; and
determining one or more snapshots not used in any of the shortest operation paths as deletion targets.

2. The non-transitory computer-readable storage medium according to claim 1, wherein:
the determining includes excluding, amongst the snapshots not used in any of the shortest operation paths, a snapshot depended on by a snapshot used in any of the shortest operation paths from the deletion targets.

3. The non-transitory computer-readable storage medium according to claim 1, wherein:
the determining includes excluding, amongst snapshots taken prior to the restoration origin state, a latest snapshot from the deletion targets.

4. The non-transitory computer-readable storage medium according to claim 1, wherein:
the procedure further comprises measuring the amount of time needed for each of the commands when causing the apparatus to execute the each command, and recording the amount of time needed to execute the each command in association with a state of the apparatus and content of the each command.

5. The non-transitory computer-readable storage medium according to claim 4, wherein:
the recording includes allowing a user to input a second command causing a state transition opposite to a state transition caused by a first command that the apparatus has executed and recording the second command in association with the first command.

6. The non-transitory computer-readable storage medium according to claim 5, wherein:
the recording includes recording, as an amount of time needed to execute the second command, the same amount of time needed to execute the first command, or recording the amount of time needed to execute the second command obtained by actual measurements.

7. The non-transitory computer-readable storage medium according to claim 4, wherein:
the recording includes recording mappings between states of the apparatus prior to and after the execution of each of the commands and snapshots taken for the apparatus.

8. A state restoration apparatus comprising:
a memory configured to store information indicating a chronological order of a plurality of states of an apparatus, information indicating an amount of time needed to execute each of a plurality of commands, causing a forward or backward transition between two of the states, and information indicating an amount of time needed for restoration to, among the states, each state for which a snapshot has been taken, using the snapshot; and
a processor configured to perform a procedure including:
calculating, based on the information, shortest operation paths, each for restoring the apparatus from a restoration origin state to one of the remaining states, and
determining one or more snapshots not used in any of the shortest operation paths as deletion targets.

9. A state restoration support method comprising:
calculating, by a computer, based on information indicating a chronological order of a plurality of states of an apparatus, information indicating an amount of time needed to execute each of a plurality of commands, causing a forward or backward transition between two of the states, and information indicating an amount of time needed for restoration to, among the states, each state for which a snapshot has been taken, using the snapshot, shortest operation paths, each for restoring the apparatus from a restoration origin state to one of the remaining states; and
determining, by the computer, one or more snapshots not used in any of the shortest operation paths as deletion targets.
